(19) United States
(12) Patent Application Publication
(10) Pub. No.: US 2006/0224435 A1
(43) Pub. Date: Oct. 5, 2006

(54) Method and system for quantifying relative immediacy of events and likelihood of occurrence

(76) Inventors: Kenneth F. Male, Spring Lake, NJ (US); David Taylor, Stamford, CT (US)

Correspondence Address: The Info Project, Inc., 22nd Floor, 645 Madison Avenue, New York, NY, 10022, US

(21) Appl. No.: 11/096,351

(22) Filed: Apr. 1, 2005

(51) Int. Cl. G06F 17/30

(52) U.S. Cl. 705/10

(57) ABSTRACT

A method and system for quantifying market research. In one embodiment, a method of quantifying a likelihood of a plurality of events occurring within a specified time frame includes receiving a plurality of qualitative data corresponding to each one of the plurality of events. The method also includes quantifying the qualitative data to obtain a plurality of quantitative data corresponding to each one of the plurality of events. The method also includes processing the quantitative data to determine a respective likelihood of the plurality of events occurring within a specified time. The method still further includes generating a report that standardizes the respective likelihood of the plurality of events occurring within the specified time frame.

### COPYRIGHT NOTICE

A portion of this patent document contains material that is subject to copyright protection. The copyright owner has no objection to the facsimile reproduction by anyone of the patent document, as it appears in the Patent and Trademark Office patent files or records, but otherwise reserves all copyright rights whatsoever.

### FIELD OF THE INVENTION

The present invention relates to market research and analysis. In particular, the present invention relates to a method and system for quantifying market research and other kinds of data.

### BACKGROUND OF RELATED ART

The present invention relates to market research and analysis. Corporate executives, marketers and advertisers have developed several ways to gauge product success. Known techniques include for example, focus group testing, examining product market share, technology or vendor preference, technologies or vendors used most often, customer satisfaction or purchase frequency. These techniques, however, do not indicate the relative immediacy and likelihood of the occurrence of product success.

### BRIEF SUMMARY

The present invention relates to a method and system for quantifying market research and other kinds of data. In particular, the invention relates to the relative immediacy of events and their likelihood of occurring. For example, prioritization of technology purchases and implementation, technology market opportunity, assess the likelihood of adoption of technology, assess the likelihood that a particular technology will dominate a field of related technologies, predict success of technology, forecast trends for growth in technology, evaluate and compare technology and technology companies, and identify technology spending.

Generally, the invention identifies current technology implementation and future spending plans by obtaining technology information or data, analyzing the information or data, and generating an index to compare relative immediacy of projects and their likelihood of occurring. Although the invention is described herein in connection with technology data and information, it is understood that the method and system are applicable to other data or information, such as industry, products, services or other items.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a computer system in which preferred embodiments of the invention may be implemented;

FIG. 2 is a flowchart of a method according to a preferred embodiment of the invention;

FIG. 3 is a flowchart of a method according to a preferred embodiment of the invention;

FIGS. 4A-4B are questionnaires according to a preferred embodiment of the invention;

FIGS. 5A-5I are reports according to a preferred embodiment of the invention; and

FIG. 6A-6AB are pages in a report according to a preferred embodiment of the invention.

### DETAILED DESCRIPTION OF THE PREFERRED EMBODIMENTS

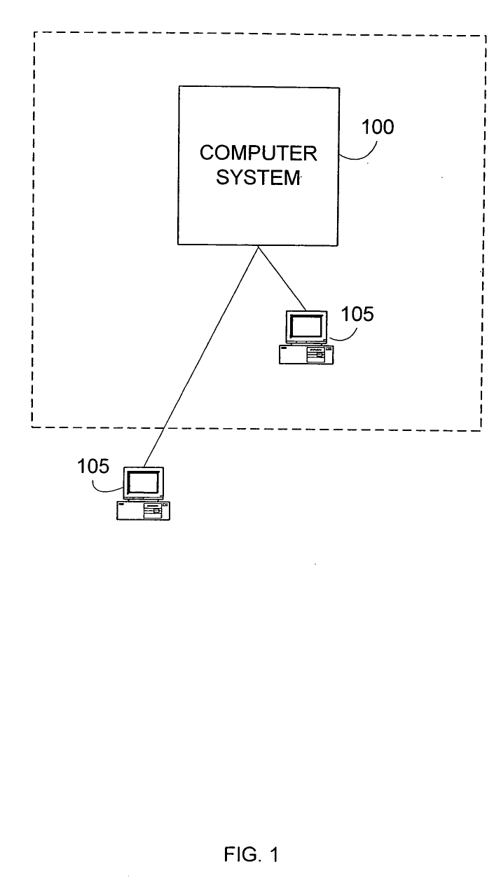

Preferred embodiments of the invention are now described with reference to the drawings. The computer system in which the preferred embodiments of the present invention may be implemented is shown in FIG. 1. The system as presented in FIG. 1 is exemplary of an appropriately programmed computer system for administering and servicing a method according to the invention. In this system, a main computer system 100 typically has one or more processors or central processing units, internal memory such as RAM and ROM, and internal storage devices such as, for example, a hard drive, a compact disc, magneto-optical storage device, and/or fixed or removable media. The computer system 100 may be, for example, an IBM personal computer with the Microsoft Windows® operating system. Instead of a single computer, there may be two or more computers which are programmed or otherwise adapted to carry out different functions or which merely combine to provide adequate computing capabilities. Indeed, computer system 100 may be comprised of any combination of computer related devices and hardware adapted and/or connected to each other in any suitable manner for administering and servicing the preferred embodiments. In addition to internal memory and memory devices, there may also be a separate storage sub-system for the storage of information logically associated with computer system 100. This storage sub-system may be located nearby, with a dedicated interface, to computer system 100 or it may be relatively distant, and connected, to computer system 100 through a network, such as an Ethernet local area network or specially designed storage network, with data sent to computer system 100 through the network or dedicated interface. The data stored by the external storage sub-system may include, but is not limited to, technology information, a questionnaire, questionnaire responses, client information, interviewer information, interviewee information and other parameters and data necessary to generate a report.

There are preferably one or more user workstations 105 connected to computer system 100. These workstations 105 may be, for example, computer terminals, personal computers, laptop computers, handheld or other devices, with a user interactive interfaces including a display and user input devices, such as, for example, a keyboard, mouse, pointing device, and/or microphone. The user workstations 105 preferably require the user to authenticate themselves as an authorized user such as by, for example, requiring a user name and password to log on to the system. Workstations 105 may be made available only internally (such as via an Intranet) of the company sponsoring the variable annuity or closely related entities, and provide account and other information to, for example, customer service representatives servicing clients of the sponsoring company. Such workstations 105 are preferably connected to computer system 100 through a network such as Ethernet. Alternatively, workstations 105 may be available externally as well as internally and provide appropriate views of information and end-client interactions to employees, agents, or the registered representatives that work with the sponsoring entity. Workstations 105 may be connected to computer system 100 using any of a variety of connection techniques to access the firm's private computer systems, including a virtual private network (VPN) over the Internet.

The method of the preferred embodiments of the present invention may be advantageously implemented using a computer program with a plurality of different modules executed by computer system 100. The computer program may be stored in internal memory or storage device, or other recording media, associated with computer system 100.

The computer program and modules can be implemented in a variety of ways, and the manner in which the program and modules are implemented is largely a matter of design choice well within the ordinary skill level of those skilled in this art. Appropriate software tools are commercially available, such as Microsoft Office®. This available software is not adapted to support the management or analysis of market research data nor is it particularly well suited for quantifying the data. Instead of an automated method, the conventional software requires the sponsoring entity to manually enter data and compose reports.

In one implementation of the preferred embodiments of the invention, the computer system 100 does not execute conventional software and instead the software is modified or new software is installed that is well suited for the preferred embodiments. This software preferably supports the appropriate interfaces for clients and personnel of the sponsoring firm to enter market research data. The software may also implement any other unique aspects of the product embodiments described in this application. For example, the software may implement a unique test to ensure that the automated trading is not administered in a manner that causes there to be improper trades or trades that cannot be executed.

The invention identifies current technology implementation and future spending plans by obtaining technology information or data, analyzing the information or data, and generating an index to compare relative immediacy of projects and their likelihood of occurring. Although the invention is described herein in connection with technology data and information, it is understood that the method and system are applicable to other data or information, such as industry, products, services or other items.

The technology information and data used to generate the index are typically obtained in an interview of technology managers, executives, users, purchasers, developers, marketers or other individuals involved in a technology field. Such individual is referred to herein as a user. Data or information used in the analysis generally includes, for example, a user's intention to purchase or implement a technology, product or service, the probability that the user's intention to act will become a reality, the immediacy of user's need to implement a technology, product or service, and resources available to turn intention into a reality. In preferred embodiments, data is collected at regular time intervals, for example, interviews are conducted every six months.

The analysis generates an index which sums up relative importance of various and multiple factors that impact a user's decision to purchase or implement a technology. Each of the factors that contribute to a purchasing decision are included in the analysis. The index shows the likelihood of a user or entity making a decision to implement a technology and is related to the immediacy of the need for the technology as well as the availability of resources necessary to make the implementation possible. In preferred embodiments of the invention, the index is used to assess technologies and technology vendors over a technology's life cycle, for example, to determine which technology or vendor will experience the greatest growth in the first eighteen months after a technology has been released. Additionally, the index can be used to determine product development prioritization and to receive an overall competitive picture of vendor profitability. The index is preferably scaled to be a percentage of 100 (the range of possible scores is 0-100). The index scores for each surveyed technology are typically 10-60%, which suggests that there is no single technology or product that over 60% of interviewees are planning to implement. High index scores indicate that a technology has a relatively higher likelihood of being purchased, used or implemented in the future. Low index scores can be either an indicator of low interest in a technology, or relatively well established or widely adopted technology, that will not change significantly in the near future.

In a preferred embodiment of the invention, the indices are compiled into a report which may additionally include other technology data. Exemplary reports include for example, End user reports which provide interview data, including detailed narratives of user responses, Investor reports which provide results of interviews of technology analysts and investors, Fusion reports which include the results of the End user and Investor reports, Time Series reports which provided comparative results of analysis over time, for example, for more than one wave.

The index and reports can be used by users or technology professionals, for example, as a reference guide in making event decisions, such as acquisition, vendor selection, or price, technology companies, for example, to provide a relative benchmark to compare success against competitors, provide an indicator of best practice, such as the most widely adopted or avoided technology, technology vendors, for example to identify market strategy, resource optimization to respond to future purchasers, and by investors, for example, to identify technology success and failures and to evaluate a technology's potential market.

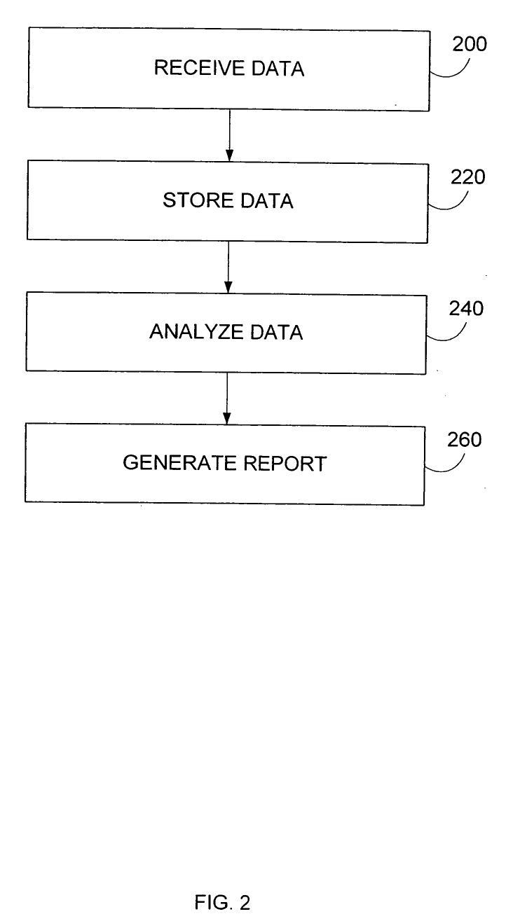

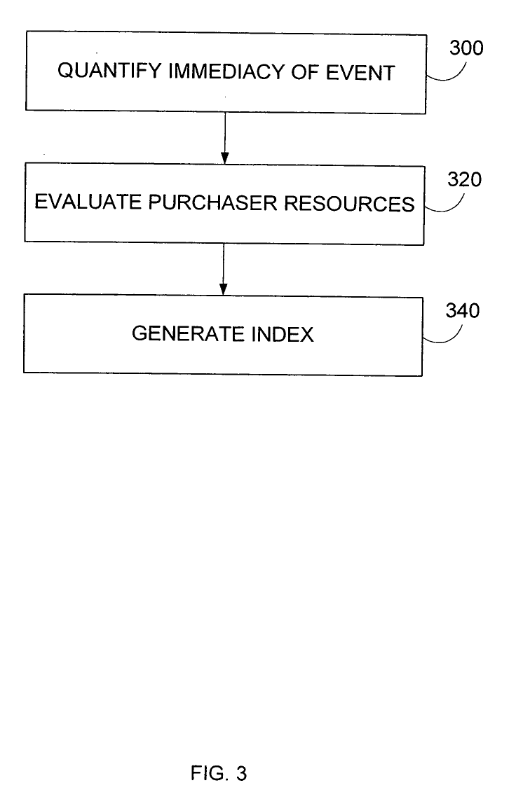

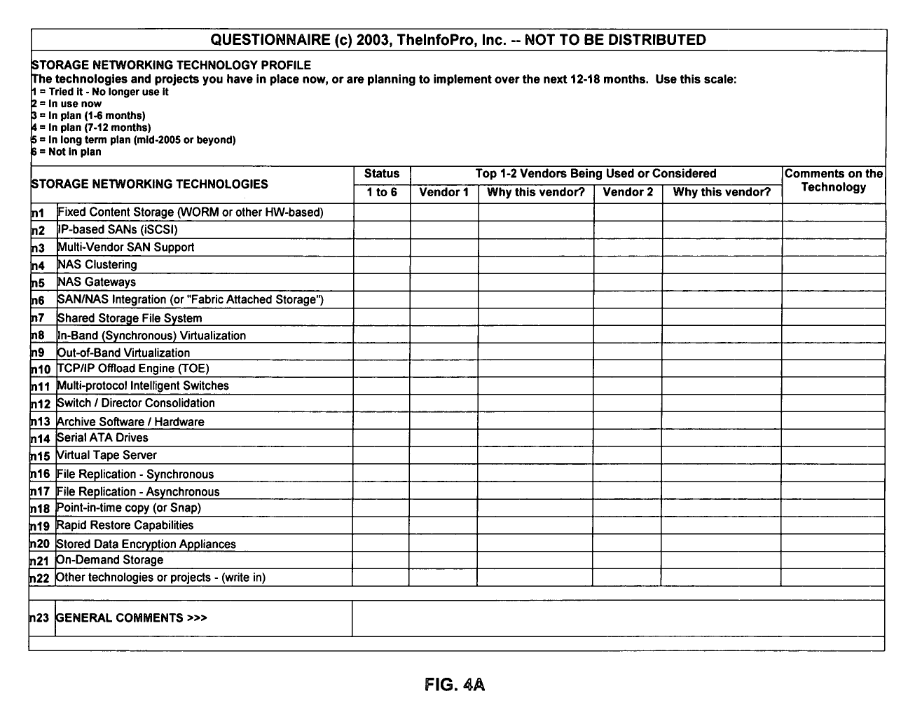

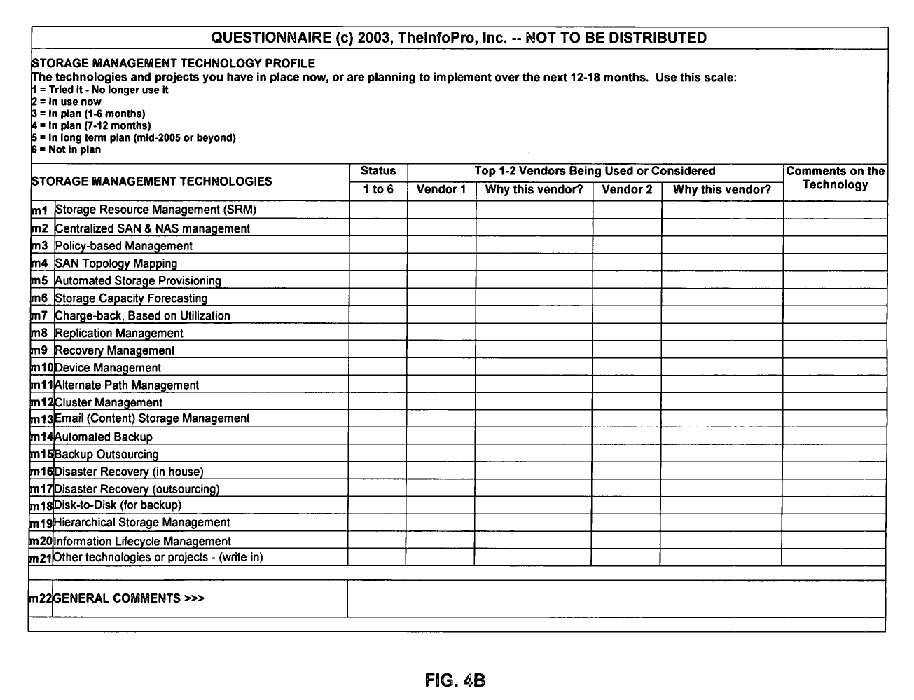

FIGS. 2 and 3 depict methods according to an embodiment of the invention. Referring to FIG. 2, data is received, step 200. The data received is generally data related to technology and opinions, for example, data related to technology information, a questionnaire, a questionnaire response, client information, interview information, technology use, resource availability, technology expenditure, technology plans, and other parameters and data necessary to generate a report. Data related to technology information can be for example, information related to a specific technology product, field of technology, or other technology information. Data related to a questionnaire can be, for example, a list of questions. Two questionnaires according to preferred embodiments of the invention are depicted in FIGS. 4A and 4B. Data related to a questionnaire response can be, for example, raw or processed answers to questionnaires, or other questionnaire response. In preferred embodiments, questionnaire responses are obtained in an interview of a technology user. Data related to client information can be information relating to a client, such as directed interests, resources, location, sales, or other information. Data related to interview information can be, for example, name or other identifier of an interviewer or interviewee, place and time of an interview, interview number and frequency, or other information related to an interview. Data related to technology use can be, for example, data indicating the technologies in place or in use. Data related to resource availability can be data such as assets available to a purchaser or other resource data. Data related to technology expenditure generally relates to past technology purchases. Data related to technology plans can be, for example, future technology needs or technology purchase plans.

Referring to FIGS. 4A and 4B, which depict a questionnaire according to an embodiment of the invention, a list of technologies, such as storage networking technologies in FIG. 4A and storage management technologies in FIG. 4B is listed, n1-n23 and m1-23 in FIGS. 4A and 4B, respectively. In preferred embodiments of the invention, questionnaires include several technology products or related technology items, such as 20-40 items to provide a meaningful comparison across a particular technology field. Each technology is assigned a score, such as status 1-6 according to whether a whether the technology is being used or will be implemented. For example, 1=the technology has been tried and is no longer in use, 2=the technology is in use now, 3=the technology is planned to be implemented in the near future, such as in the next 1-6 months, 4=the technology is planned to be implemented at a later date, such as in the next 7-12 months, 5=the technology is planned in the long term, such as more than one year, and 6=a technology not planned for implementation.

Referring again to FIG. 2, in preferred embodiments, the data is received at more than one time period. For example, data is received at intervals of several months, such as every six months, to track changes in response data over time.

In preferred embodiments, the data is entered in a spreadsheet, such as Microsoft Excel. In some embodiments of the invention, the data is obtained through interviews, such as in person interviews of persons involved in technology, for example, technology executives, technology experts, or persons responsible for technology evaluation or technology acquisition and entered into a computer or other receiving system such as in pre-assigned cells in the spreadsheet questionnaire depicted in FIGS. 4A and 4B. In preferred embodiments, the Excel cells are defined as either a quantitative or qualitative question. For quantitative questions, pre-assigned response codes are provided. For qualitative questions, response codes are generally not provided. When response codes are provided, the response codes are available to both the interviewer and the interviewee during an interview, for example, using the “comments” feature of Excel, which shows the appropriate response codes when a computer mouse is moved over the pre-assigned cell. For questions that are both quantitative and qualitative, two Excel cells are pre-assigned. In other embodiments of the invention, the data is entered in a computer having a user interface which provides for example, screens including a questionnaire, such as the questionnaire of FIGS. 4A and 4B.

In general, questionnaires include questions relating to topics such as: technology, technology vendors, technology management, or other relevant topics. More specifically, topics include, for example: technology or products used, spending on the technology or products and vendor, general strengths and weakness of vendors, as well as the reason for selecting the vendor and the likelihood of switching from the vendor to a competitor, competitive position, customization, deal making, delivery, ease of doing business, innovation, interoperability, product quality, quality of the sales team, reputation, technology support and vision, plans to implement technology, what vendor is selected for the implementation, why a specific vendor or technology was implemented, user environment, budget, organizational structure, and other topics.

In preferred embodiments of the invention, interviews are conducted using a substantially similar questionnaire are regular intervals, such as every six months. Keeping the questions static allows for the analysis to include measurements of changes in responses over time. In some embodiments of the invention, questions included in questionnaires are kept the same, but the list of technologies queried changes.

Referring again to FIG. 2, the received data is stored, step 220. In a preferred embodiment of the invention, the data is stored to a computer, such as an interviewer's laptop or transferred and stored to a central storage facility, such as a networked database. In general, storing the data may include uploading the spreadsheet data to a central server, converting the spreadsheet data, for example, using macros, such as TransferText functions, visual basic macros, modules, software or other process to convert it into another format, such as Microsoft Access format. In preferred embodiments of the invention, a macro is run that divides response codes into logical groups. An example of code for preparing a questionnaire and questionnaire responses for storage in a database:

Sheets.add
Sheets(“Sheet1”).Select
Sheets(“Sheet1”).Name =“USER_PROF”
Sheets(“Codes”).Select
Range(“B41:C41”).Select
Selection.Copy
Sheets(“USER_PROF”).Select
Range(“A1:A2”).Select
Selection.PasteSpecial Paste:=xlValues, Operation:=xlNone,
SkipBlanks:= _{—}
False, Transpose:=True

An example of code for restructuring two questionnaire sections so that the database can read it as part of a one-to-many relationship:

```
‘V1’
  Sheets(“Codes”).Select
  Range(“B293:C309”).Select
  Selection.Copy
  Sheets(“IN_USE”).Select
  Range(“B1:R2”).Select
  Selection.PasteSpecial Paste:=xlValues, Operation:=xlNone,
  SkipBlanks:= _{—}
    False, Transpose:=True
  Sheets(“Codes”).Select
  Range(“B362:C374”).Select
  Selection.Copy
  Sheets(“IN_USE”).Select
  Range(“S1:AE2”).Select
  Selection.PasteSpecial Paste:=xlValues, Operation:=xlNone,
  SkipBlanks:= _{—}
    False, Transpose:=True
‘V2’
  Sheets(“Codes”).Select
  Range(“C310:C326”).Select
  Selection.Copy
  Sheets(“IN_USE”).Select
  Range(“B3:R3”).Select
  Selection.PasteSpecial Paste:=xlValues, Operation:=xlNone,
  SkipBlanks:= _{—}
    False, Transpose:=True
  Sheets(“Codes”).Select
  Range(“C375:C387”).Select
  Selection.Copy
  Sheets(“IN_USE”).Select
  Range(“S3:AE3”).Select
  Selection.PasteSpecial Paste:=xlValues, Operation:=xlNone,
  SkipBlanks:= _{—}
    False, Transpose:=True
```

An example of saving one section of the questionnaire to a personal computer:

Sheets(“USER_PROF”).Select
ActiveWorkbook.SaveAs Filename:=“C:\temp\USER_PROF.txt”,
FileFormat:= _{—}
xlText, CreateBackup:=False

An example of the Access Macro that may be used to upload questionnaire response data files to a networked database:

Properties

| | | | |
|---|---|---|---|
| Container: | Scripts | Date Created: | 10/22/2003 1:00:25 PM |
| Last Updated: | 10/22/2003 1:00:25 PM | Owner: | admin |
| UserName: | admin | | |

Actions

| Name | Condition | Action | Argument | Value |
|---|---|---|---|---|
| | | Transfer Text | Transfer Type: | Import Delimited |
| | | | Specification Name: | INUSE Import Specification |
| | | | Table Name: | INUSE |
| | | | File Name: | C:\TEMP\INUSE.TXT |
| | | | Has Field Names: | No |
| | | | HTML Table Name: | |
| | | | Code Page: | |
| | | Transfer Text | Transfer Type: | Import Delimited |
| | | | Specification Name: | OPS Import Specification |
| | | | Table Name: | OPS |
| | | | File Name: | C:\TEMP\OPS.TXT |
| | | | Has Field Names: | |
| | | | HTML Table Name: | |
| | | | Code Page: | |

Data stored to a database is generally divided into multiple tables, each corresponding to logical groups. Each table contains both long text (more than 255 characters, short text (255 or fewer characters) or a number (typically for coded data or actually number such as percentages or dollar figures). The structural components of note in this database are the data key, data structure, table relationships and user interface. The data is assigned a key or identifier, such as the interviewee's email address. The tables are typically related using a one-to-one relationship. However, when there are multiple responses from a single user, such as relationships between a user and multiple vendors, a one-to-many relationship is used. Each table has a corresponding form, which can be used for narrative searches, data cleaning or verification or post-hoc coding. Each of these forms contains a subform that holds the interviewee's demographic data. Each form is connected through a “switchboard” interface provided by Excel.

In some embodiments of the invention, the data is cleaned or verified, for example, for completeness, logic, consistency, grammar, quantitative, or post-hoc coding. Verifying the data for completeness can include for example, resolving any missing data or data in a non-numeric format. Verifying the data for logic can include for example, ensuring that responses fit a logical pattern, such as checking percentage values of budgets for a total of 100%, or if a response indicates that a technology is not installed, there should not be a response indicating the supplier of that technology. Verifying for consistency can include for example, spelling vendor names, technology or products. Quantitative Cleaning can include for example, code cleaning, product categorizations, or “other” response which require categorization. Post- Hoc Coding can include for example, adding codes which fit narrative responses, or other coding. In addition, an overall quality rating may be assigned to an interviewee and interview response data to provide interviewer feedback.

The data is analyzed, step 240. The data analysis includes data extractions, and querying a database, such as a Microsoft Access database. In preferred embodiments of the invention, codes for analyzing the data are built in to the questionnaire Excel spreadsheet. For example, each question in the questionnaire has a corresponding question on a codes page. The questions run down the left hand column of the spreadsheet (column A:1-N). The first question on the page is the first question in the questionnaire; the last question on the codes page is the last question on the questionnaire. For each question there is a corresponding response cell in the second column (column B:1-N). This corresponding cell has a reference equation to the cell in which the actual response is typed by the interviewer (e.g “=‘In Use’!C17”). In this way, all of the responses are coded into one long hidden spreadsheet at the back of each interview book.

The data analyzed is obtained from a database using SPSS get statements. The resulting quantitative data is analyzed using SPSS. The advantage of using get statements rather than saving static data files is that data runs can be pre-coded and therefore can be run on interim data, or can be easily and quickly run in the case of an emergency. The majority of the coding is done using table syntax, but more advanced analysis such as cluster analysis and regression can be preformed on the same data set.

The following is an example of the SPSS syntax used to extract data from the research database (note (. . . ) signifies code not shown):

```
GET DATA /TYPE=ODBC /CONNECT=
‘DSN=MS Access Database;DBQ=\\Srvtip01\shared\Research\STORAGE ’
  ‘3\Data\Storage 3.mdb;DriverId=25;FIL=MS Access;MaxBufferSize=2048;’
  ‘PageTimeout=5;’
/SQL = ‘SELECT ‘T0‘.‘i1_1n‘ AS ‘i1_1n‘, ‘T0‘.‘i3a_1q‘ AS ‘i3a_1q‘, ‘T0‘.‘i3b_1q‘ AS
‘i3b_1q‘, ‘T0‘.‘i4_1q‘ AS ‘i4_1q‘, (...) ‘T0‘.‘i5a_1q‘ FROM
‘\\Srvtip01\shared\Research\STORAGE 3\Data\Storage 3‘.‘INUSE‘
‘T0‘,‘‘\\Srvtip01\shared\Research\STORAGE 3\Data\Storage 3‘.‘USER_PROF‘ ‘T8‘ WHERE
‘T8‘.‘RespID‘ = ‘T0‘. ‘RespID‘ ’.
ADD VALUE LABELS
/i3a_1q -99 “DK/NA” 1 “price or special deal” 2 “vendor promises” 3 “good references” 4
“already installed other products” 5 “ease of use” 6 “functionality” 7 “scalability” 8 “integration
with existing systems” 9 “sales team quality” 10 “viability of the company” 11 “technology
innovation” 12 “packaged (OEM'ed) with other products” 13 “recommended by primary vendor”
14 “performance” 15 “reliability” 16 “strategic relationship with vendor” 17 “mandated by
corporate or other org.” 18 “market dominance or market share” 19 “service and support” 20
“other”
(...)
VARIABLE LABELS
i1_1n “VENDOR NAME - SAN”
i3a_1q “What were your top 1-2 criteria for selecting this vendor? Why are these your top
criteria? (a) - SAN”
i3b_1q “What were your top 1-2 criteria for selecting this vendor? Why are these your top
criteria? (b) - SAN”
VARIABLE LEVEL i1_1n to i10b_8n (NOMINAL).
MISSING VALUE MISSING VALUE i3a_1q i3b_1q (...)(0,-99).
MRSETS
  /MCGROUP NAME=$i3_1 LABEL=‘What were you top 1-2 criteria for selecting’+ this
vendor’ VARIABLES=i3a_1q i3b_1q i3a_2q i3b_2q i3a_3q i3b_3q i3a_4q i3b_4q i3a_5q
i3b_5q i3a_6q i3b_6q i3a_7q i3b_7q i3a_8q i3b_8q (...)
/DISPLAY NAME=[$i3_1 $i6_1 $i7_1 $i8_1 $i9_1 $i10_1].
```

SPSS syntax is used to extract data tables, crosstabs and model development.

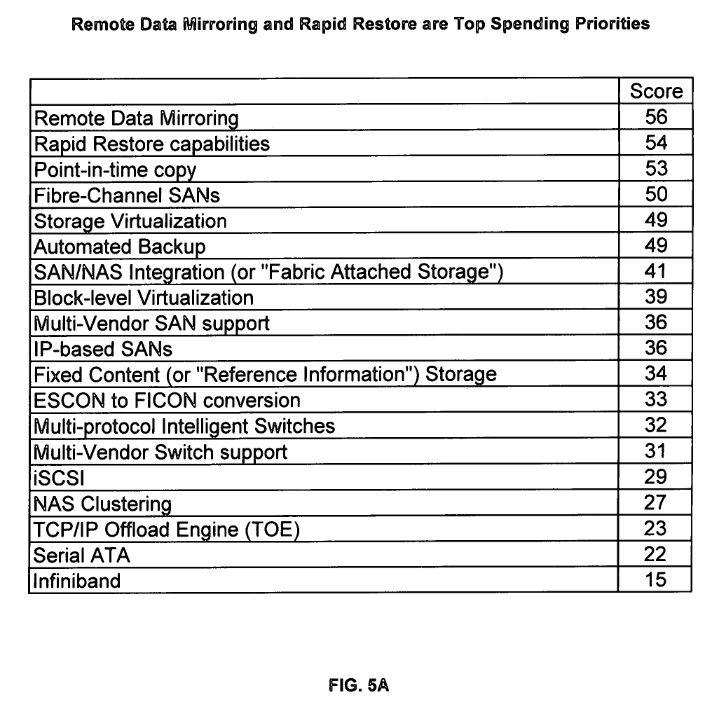

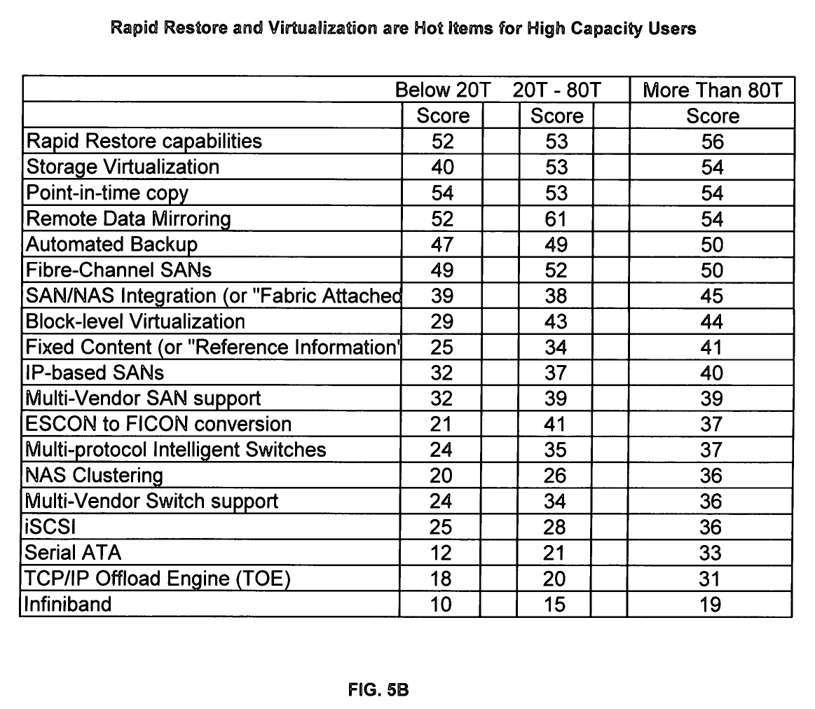

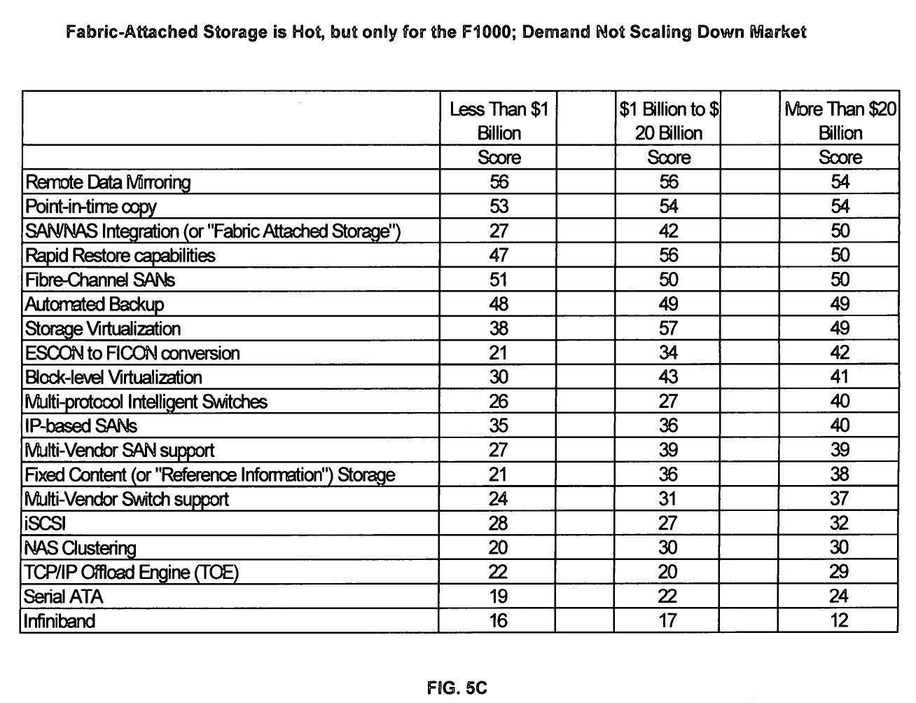

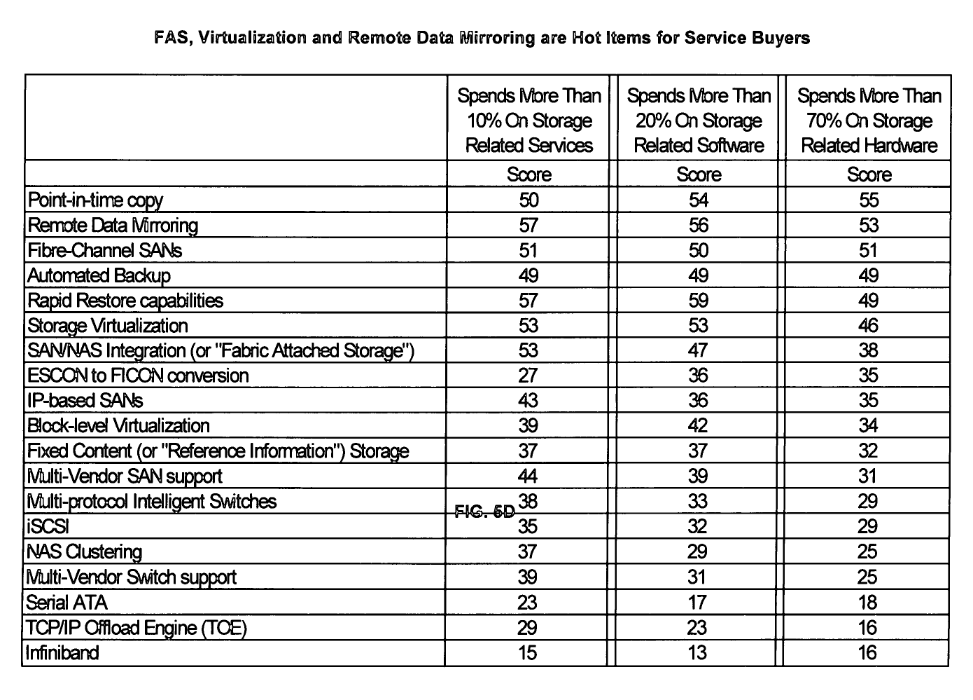

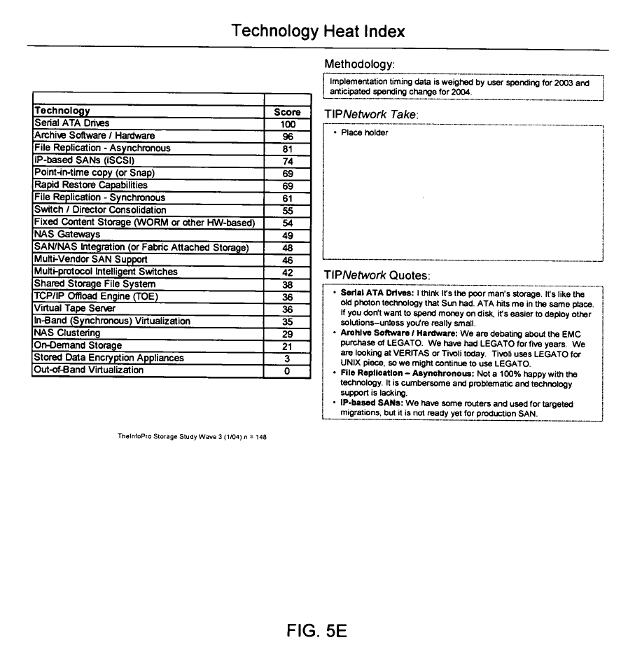

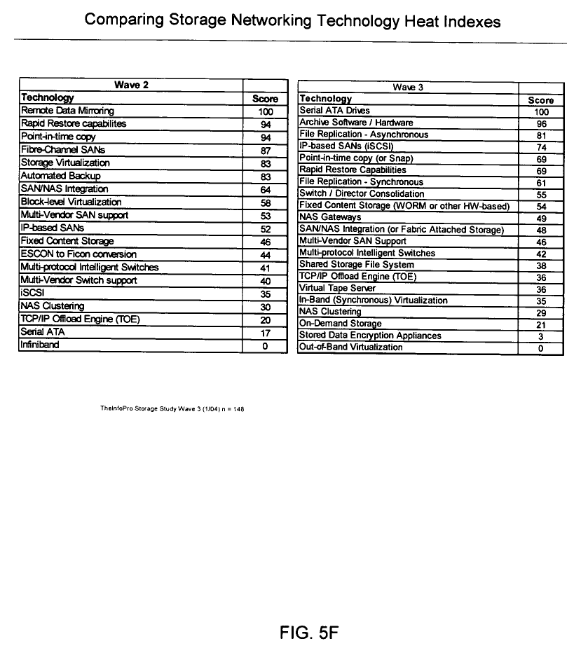

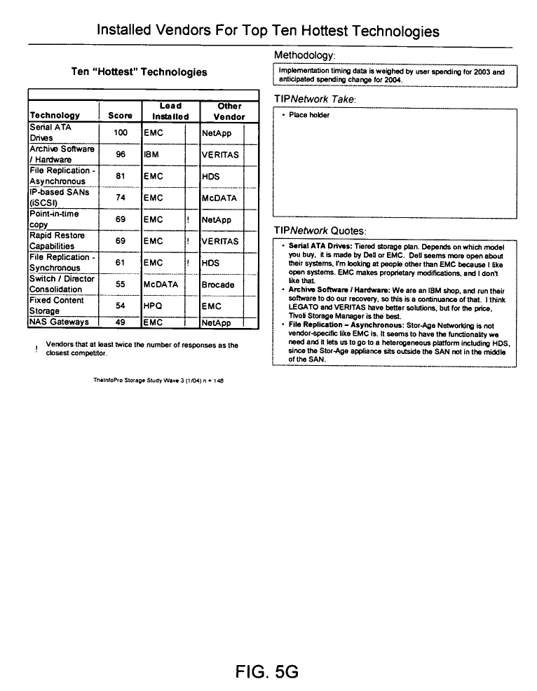

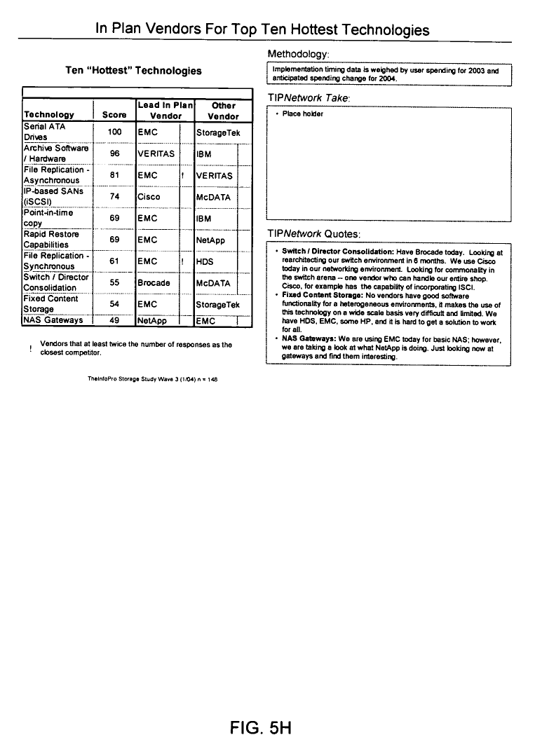

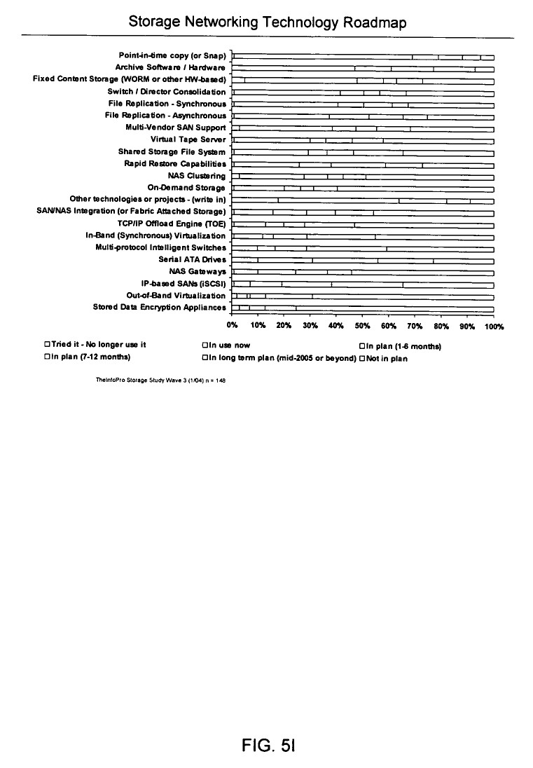

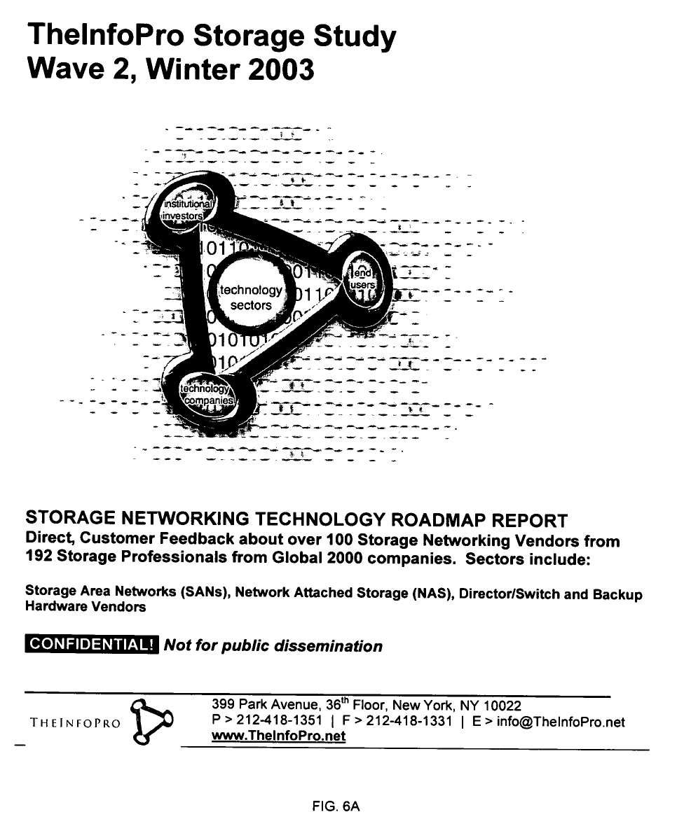

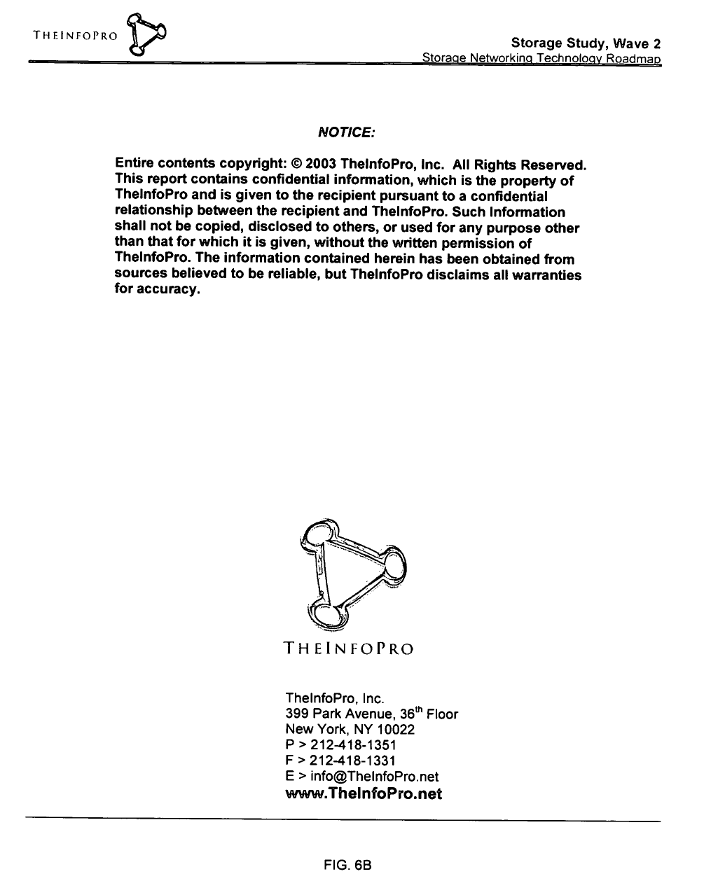

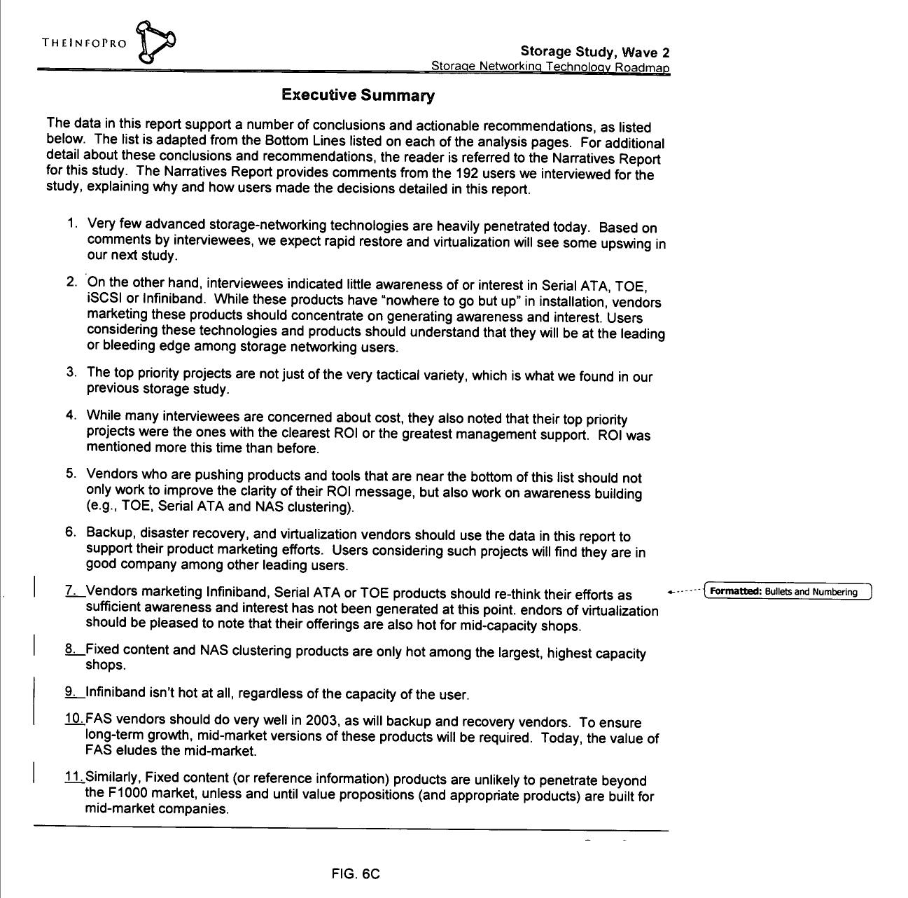

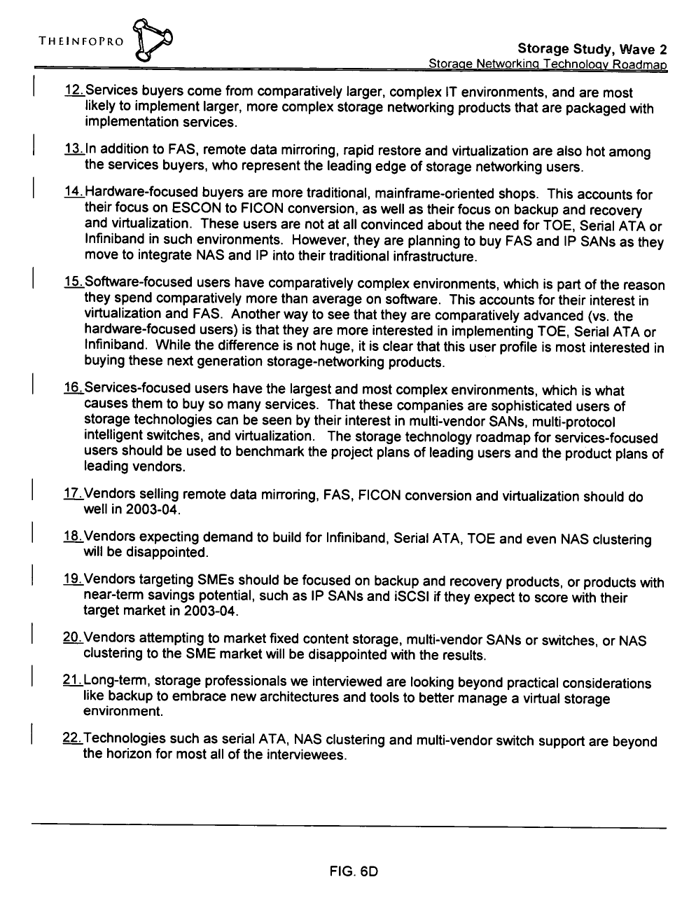

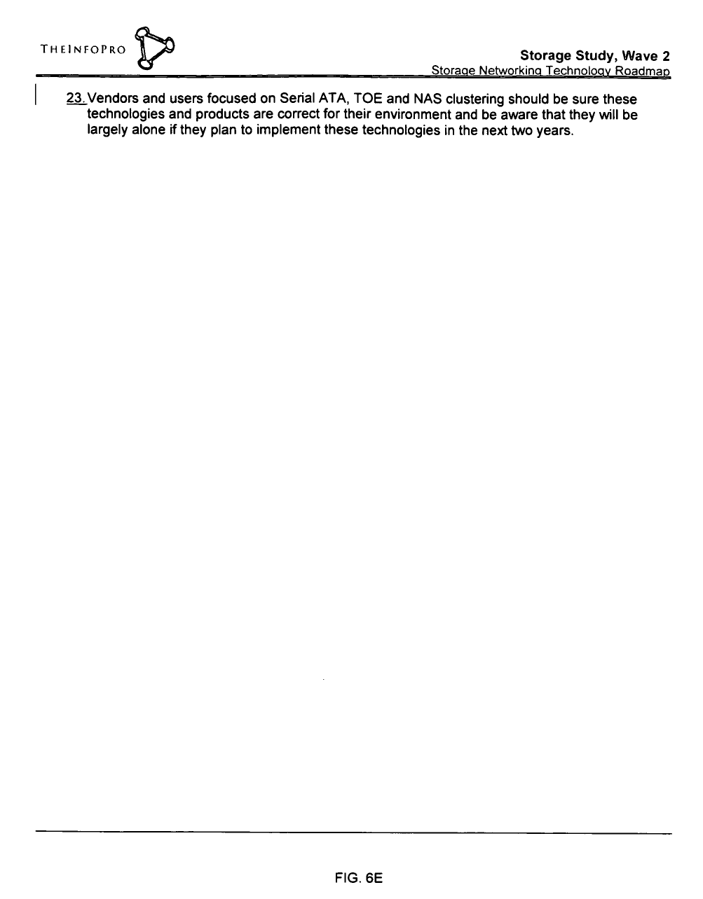

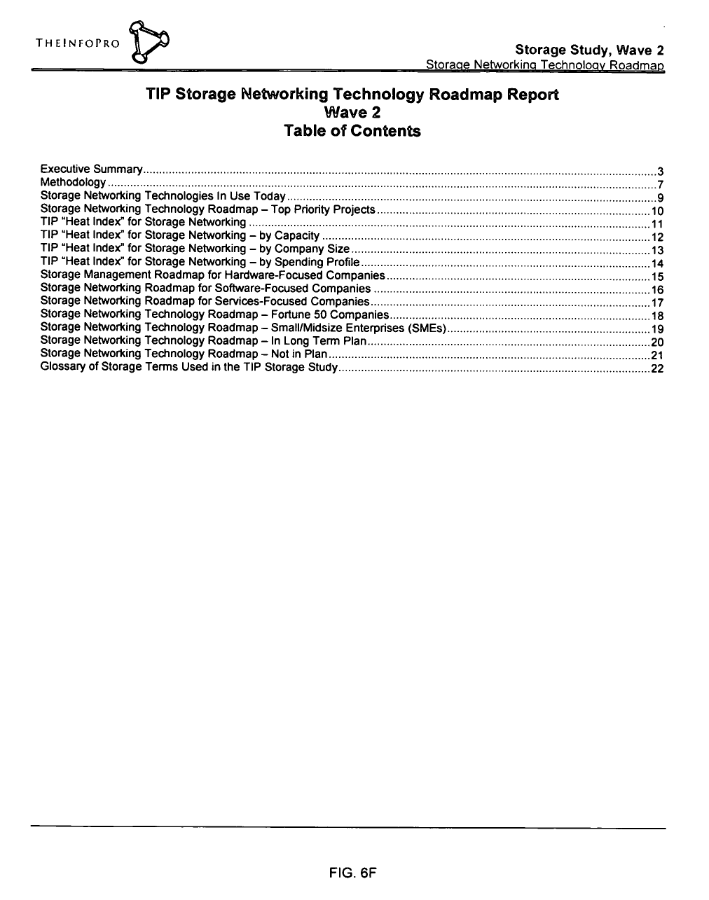

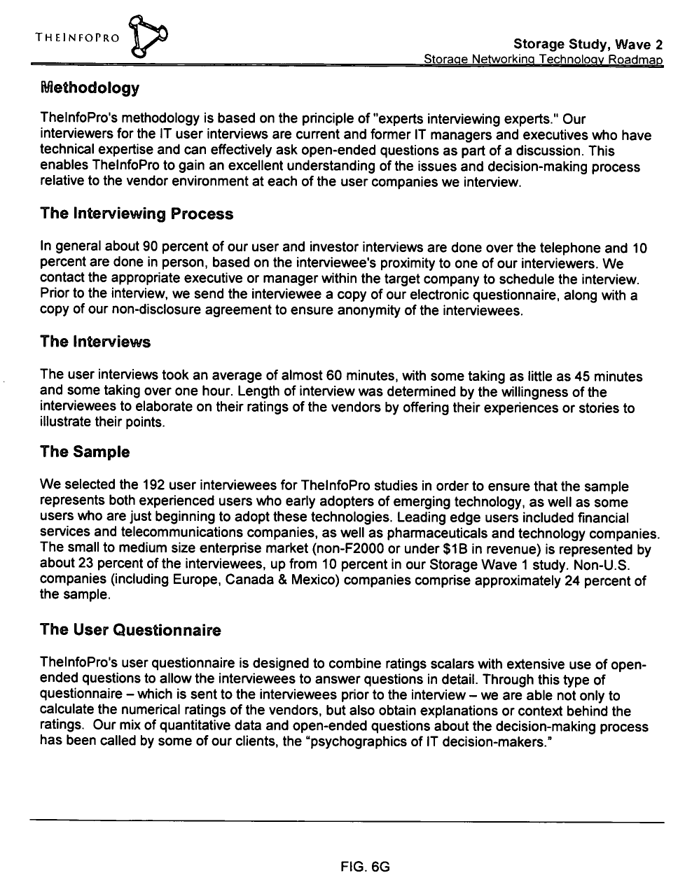

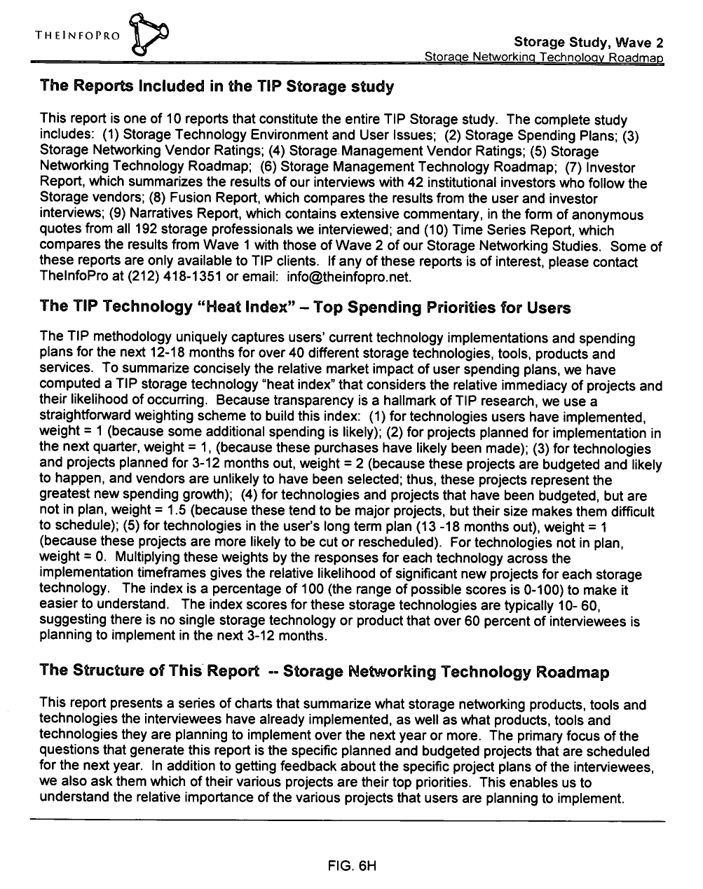

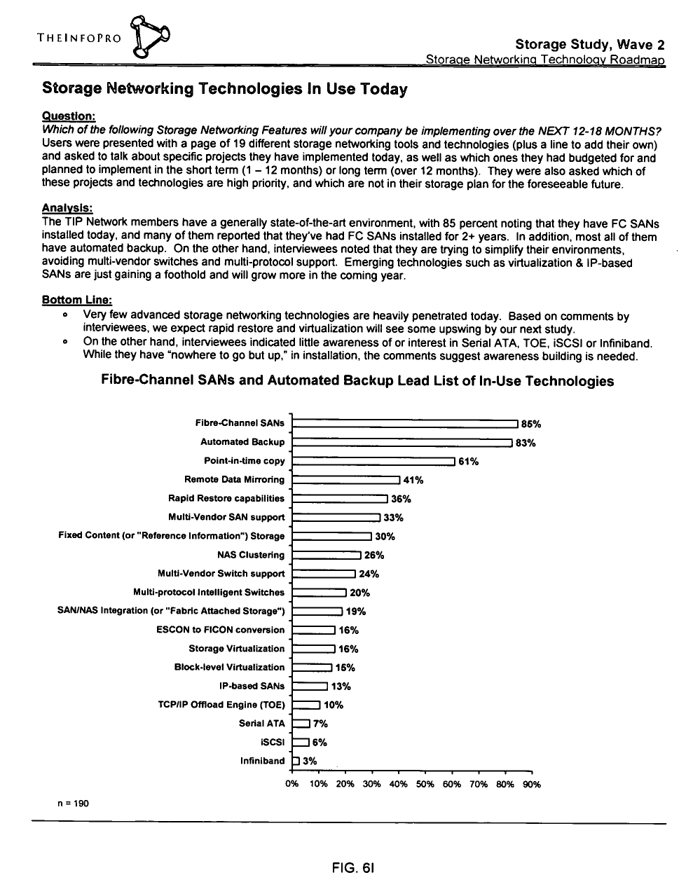

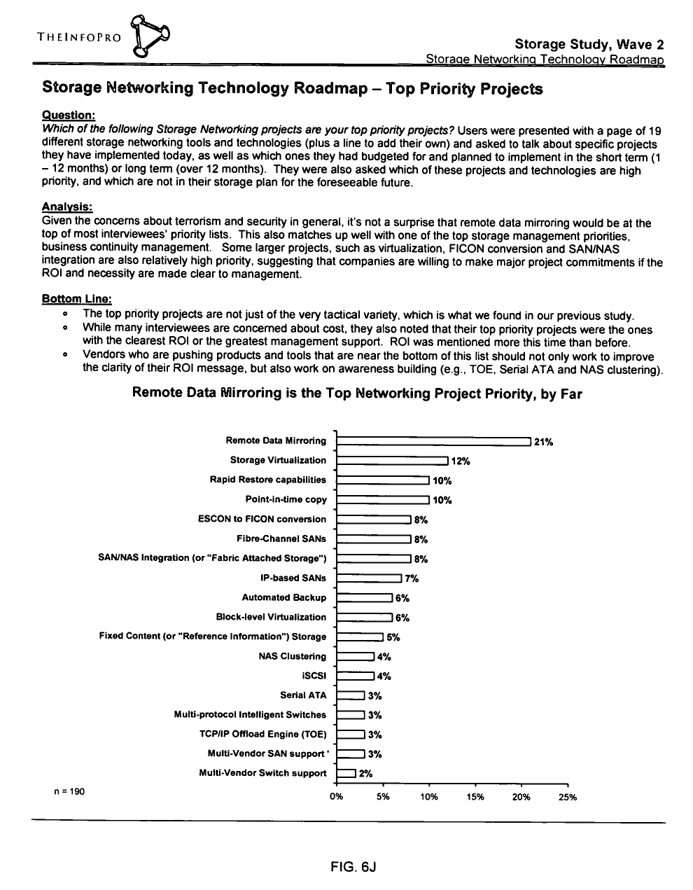

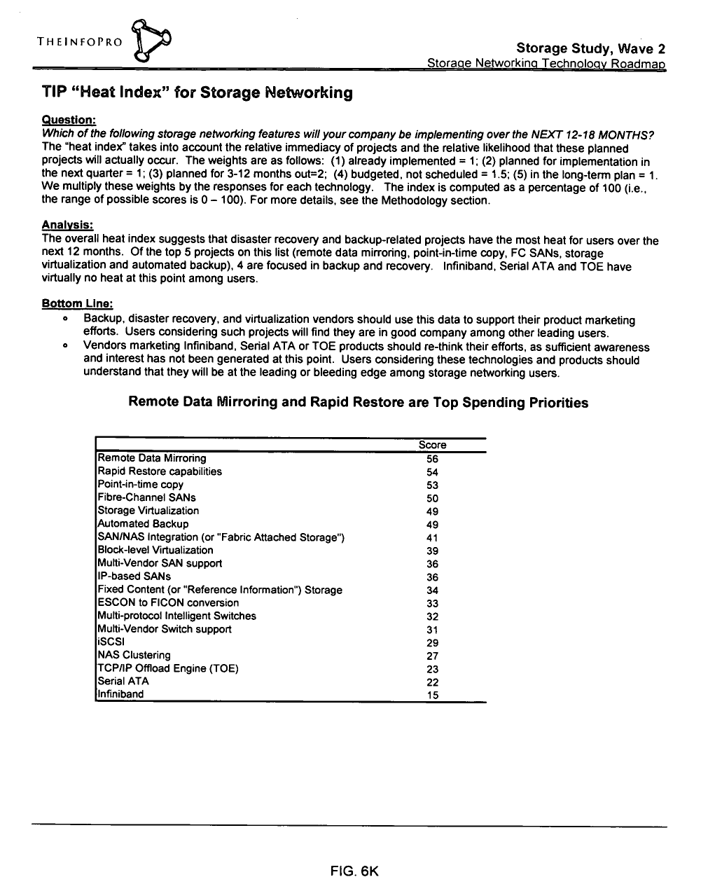

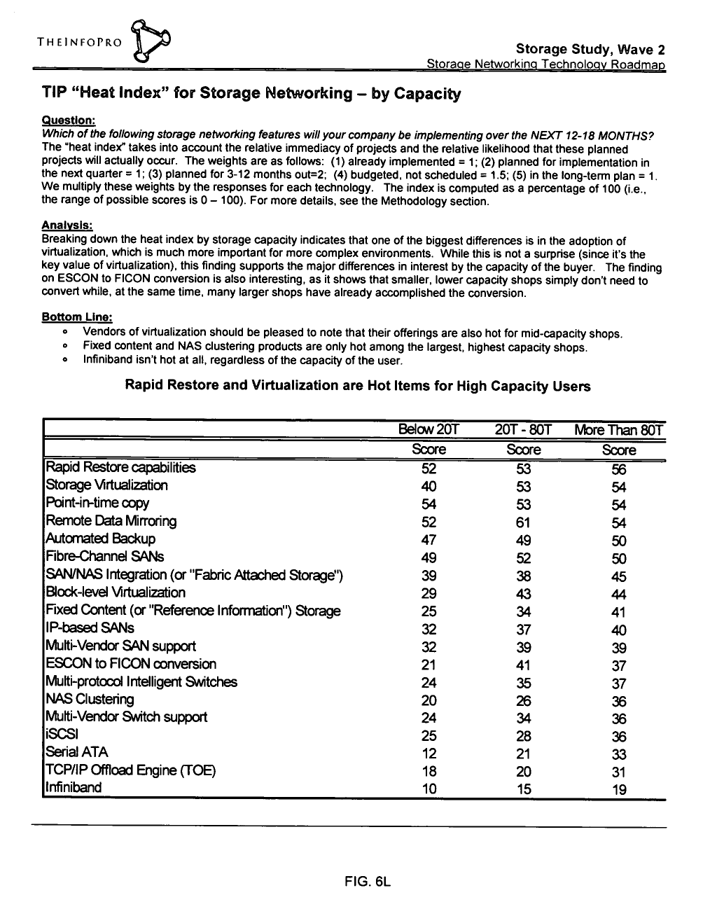

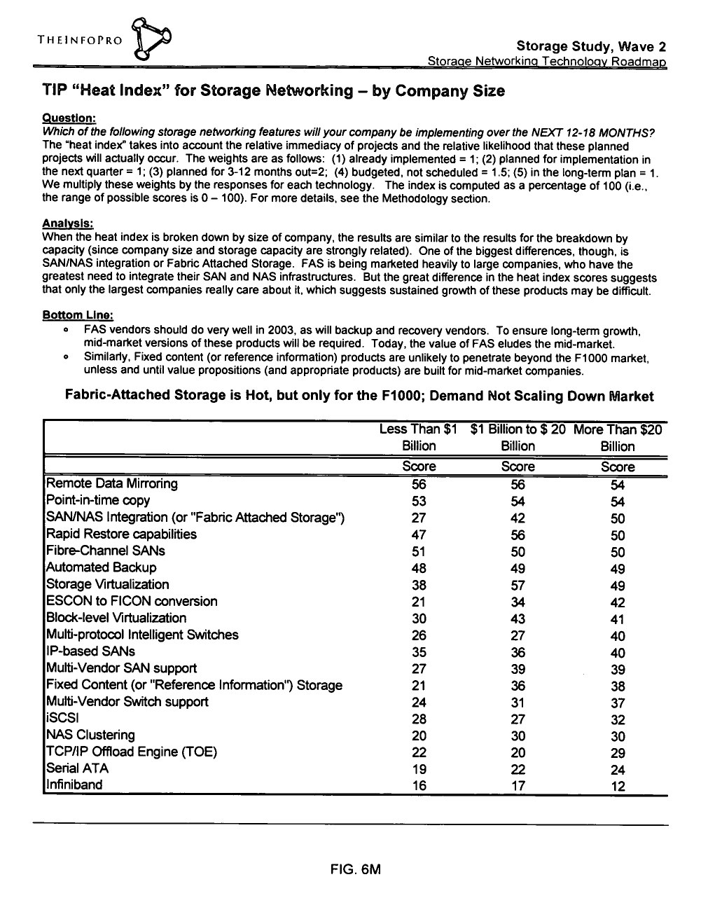

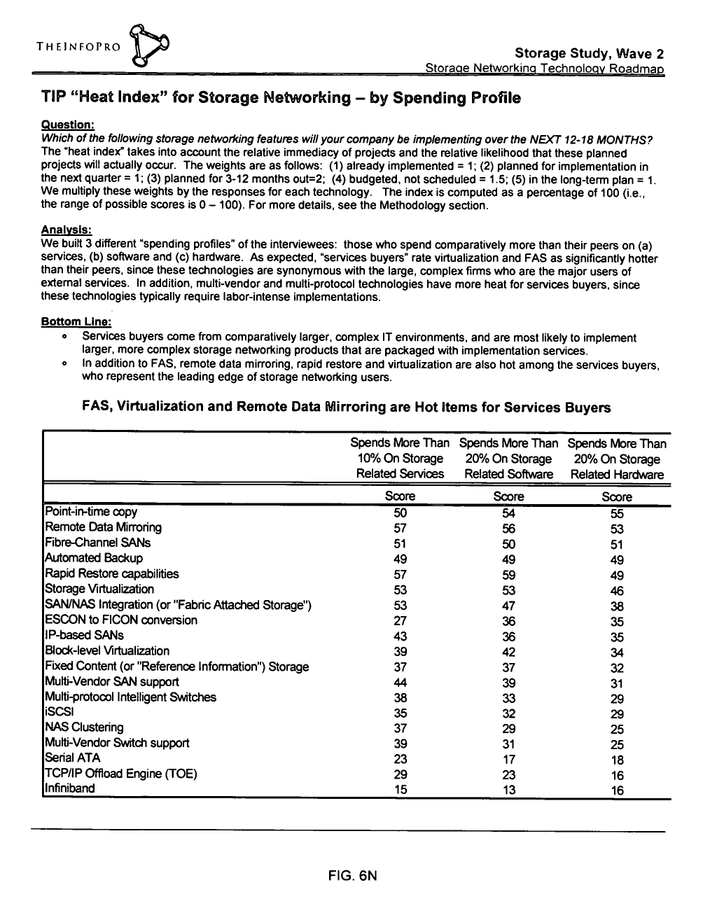

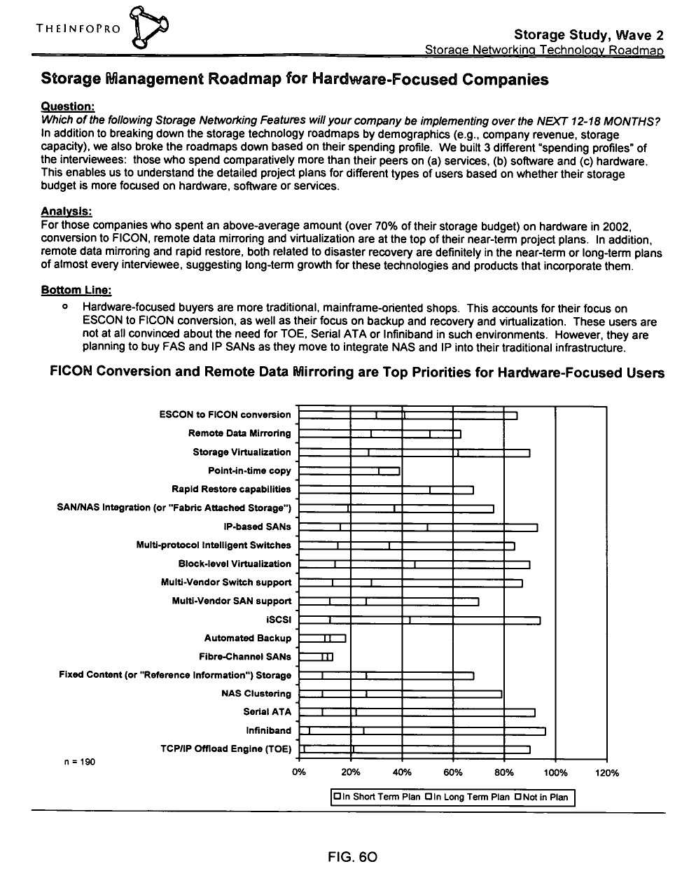

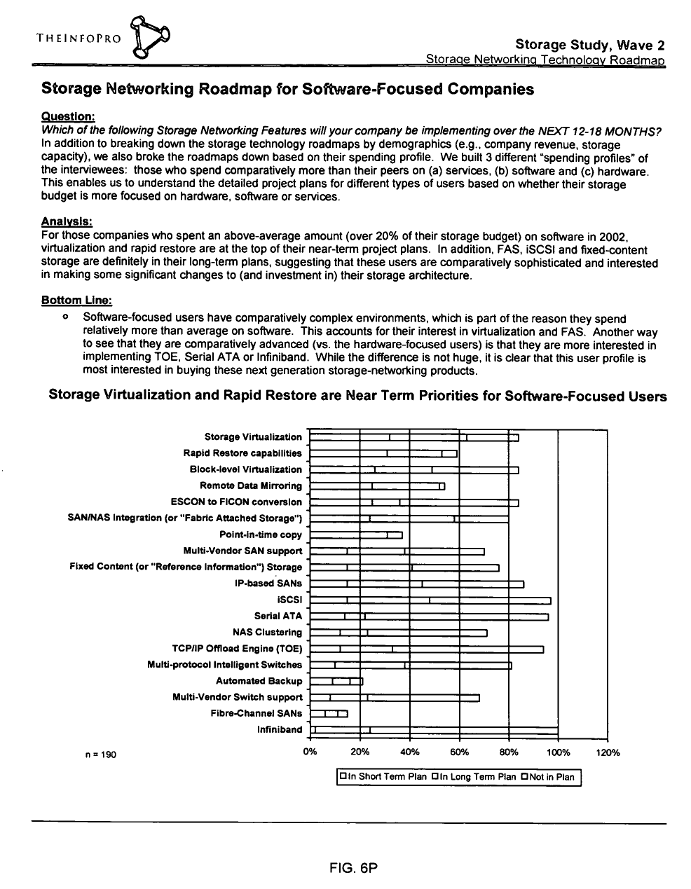

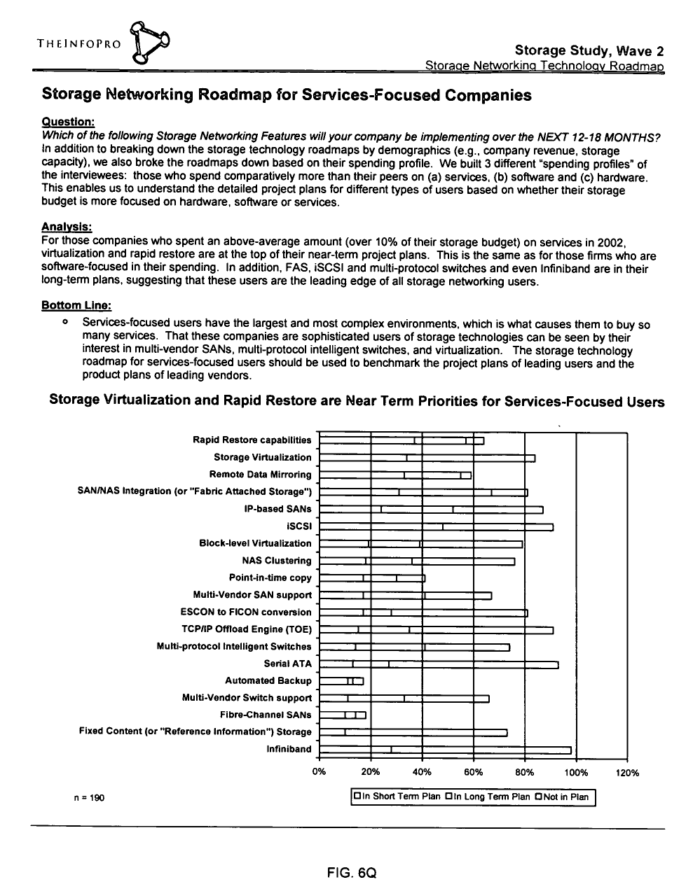

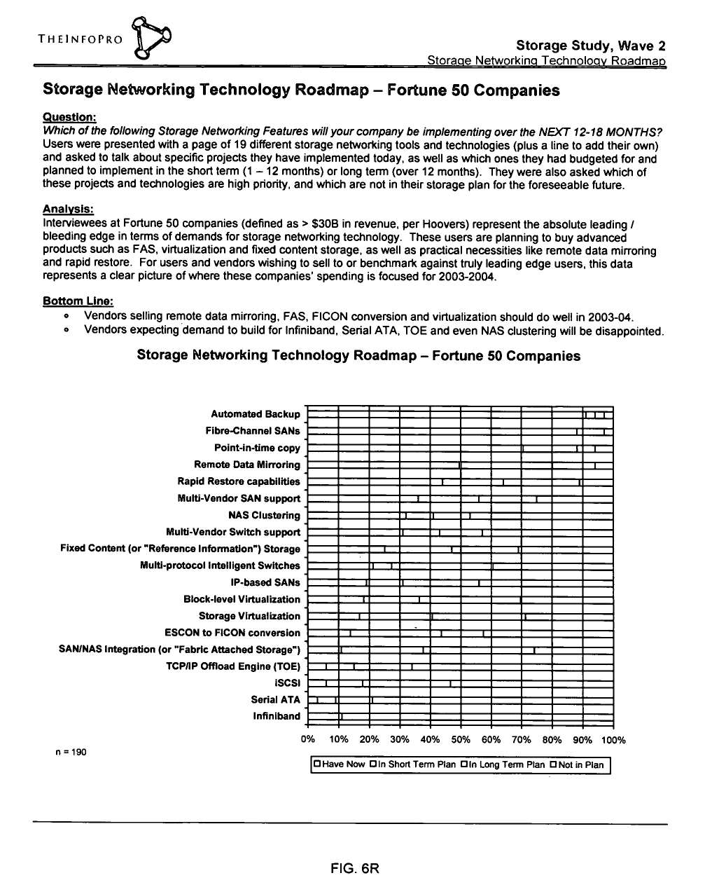

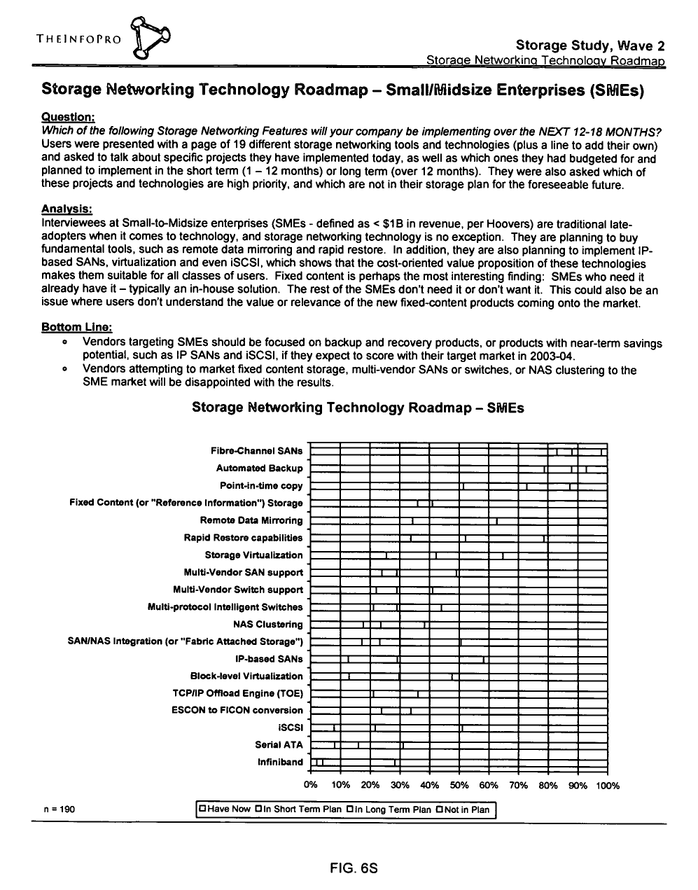

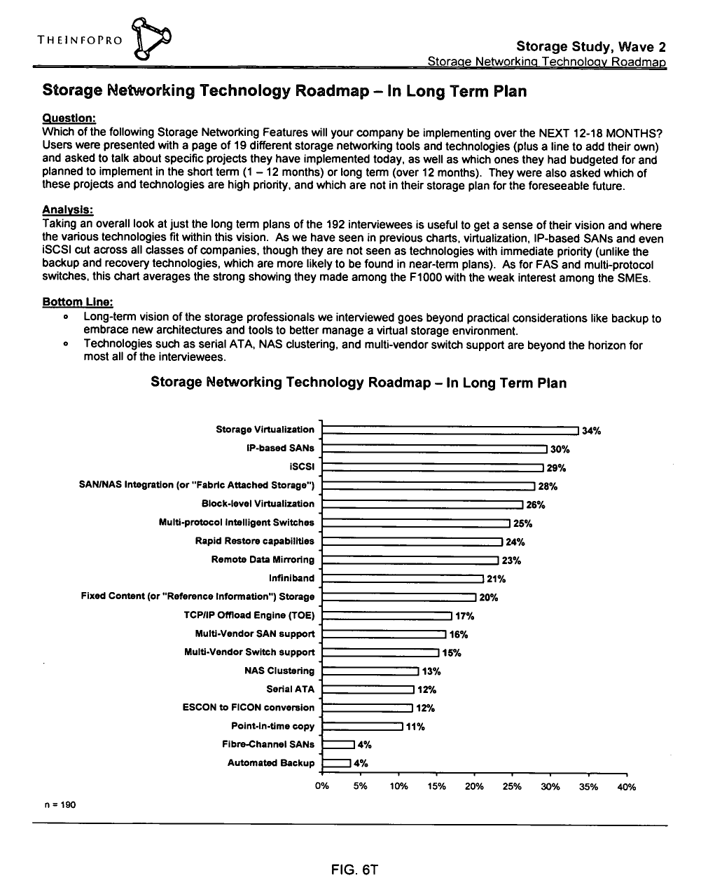

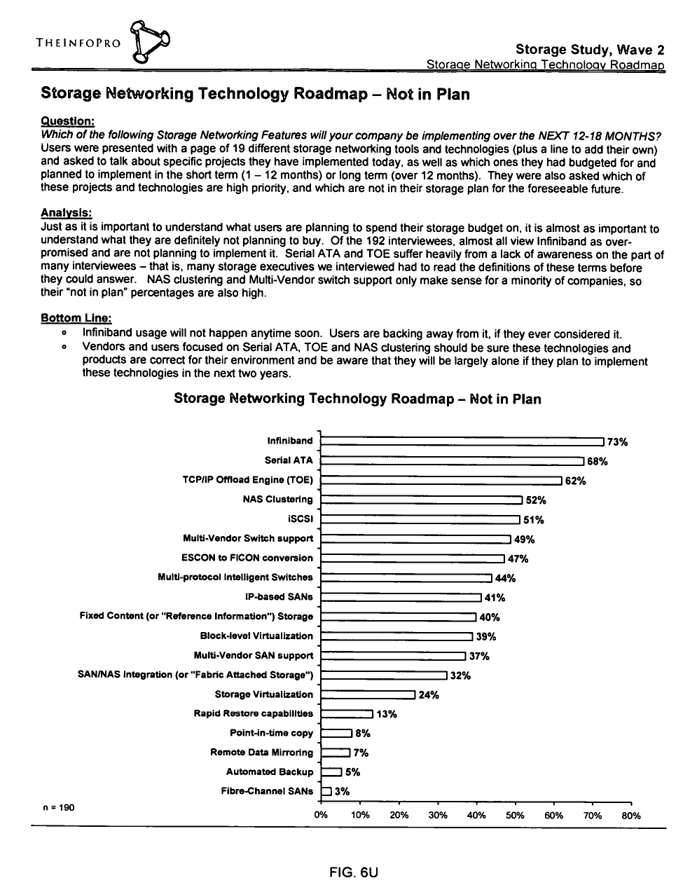

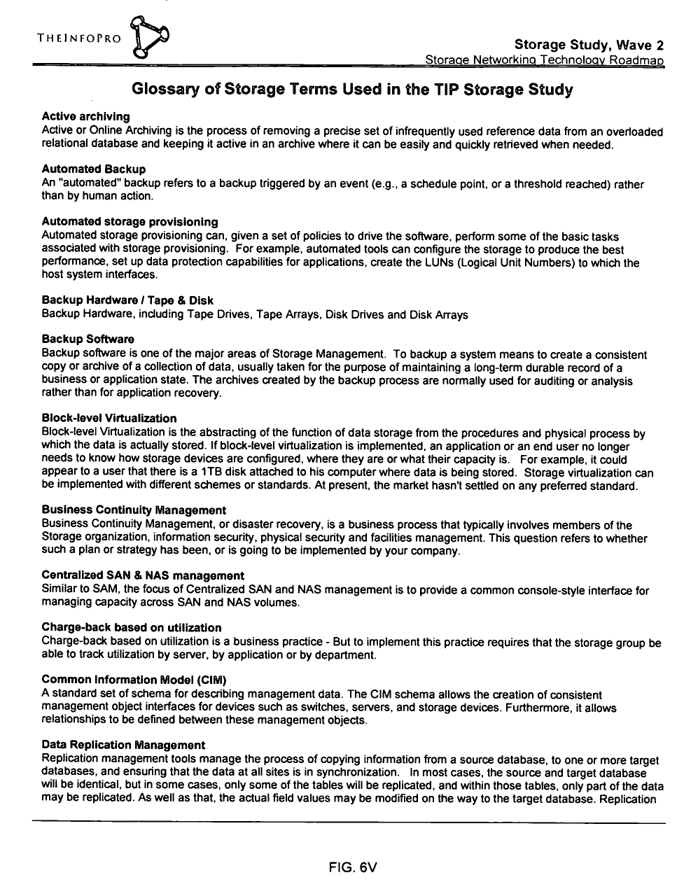

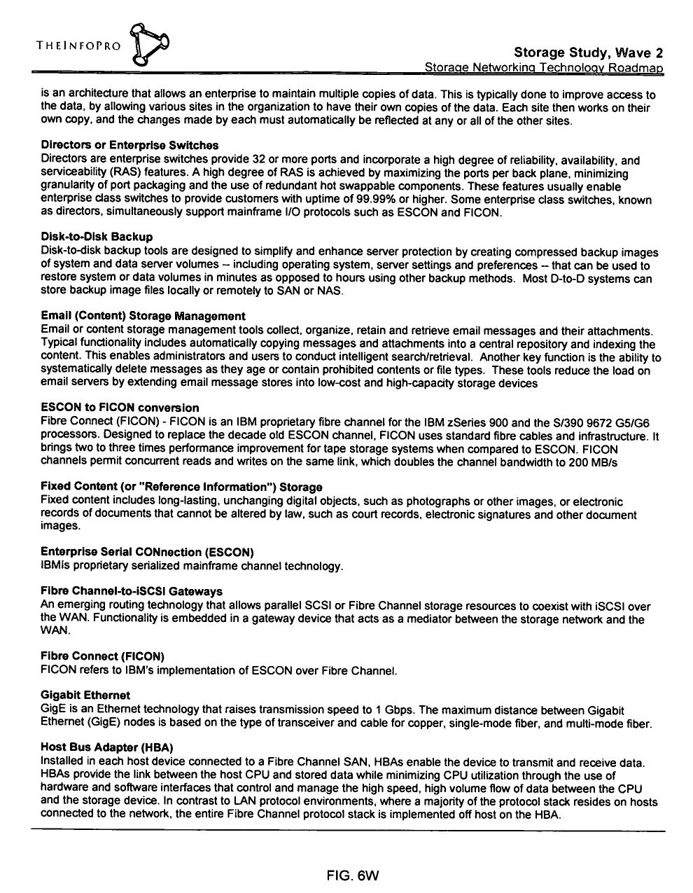

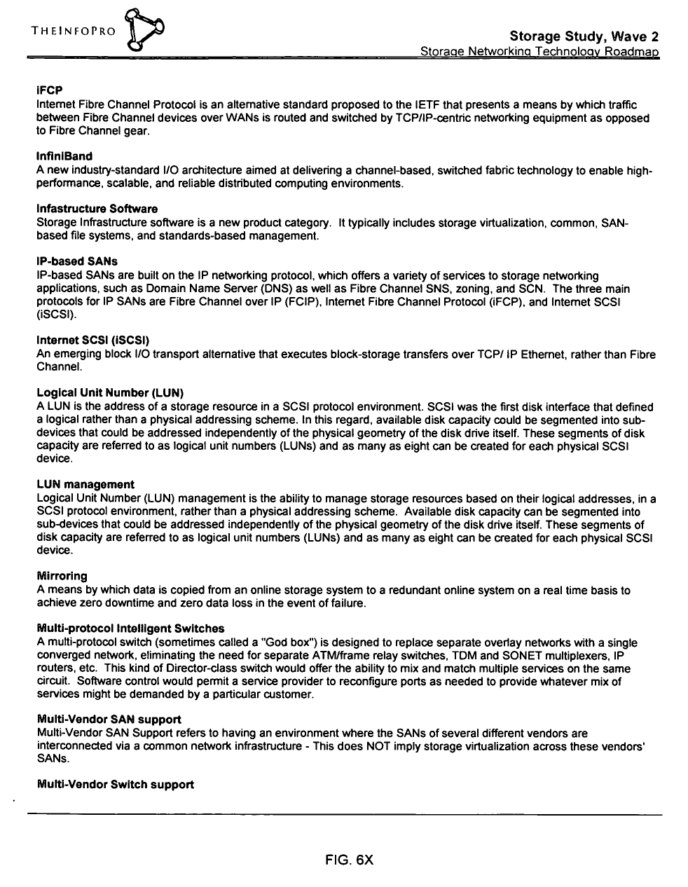

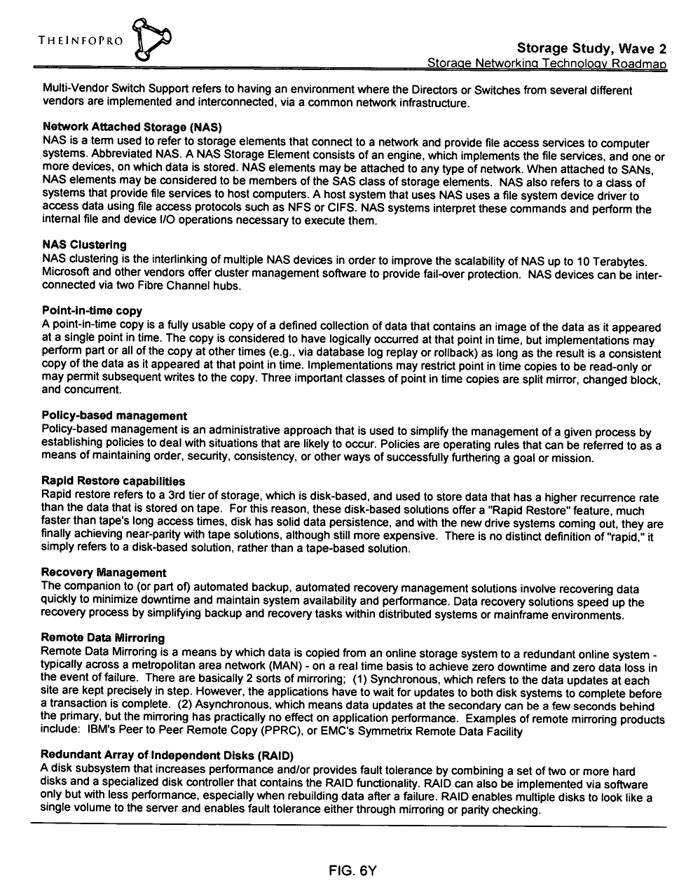

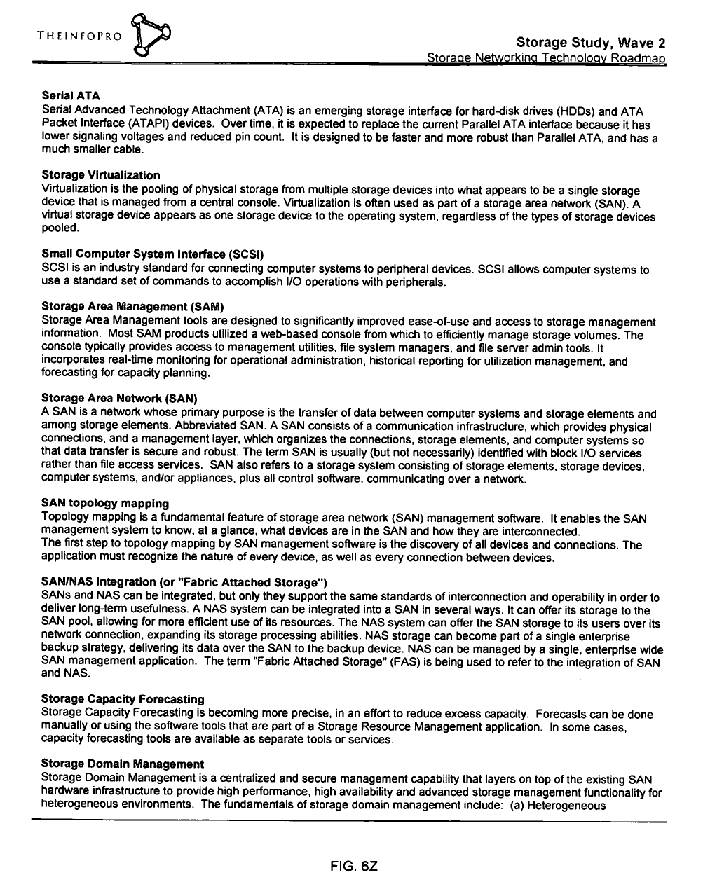

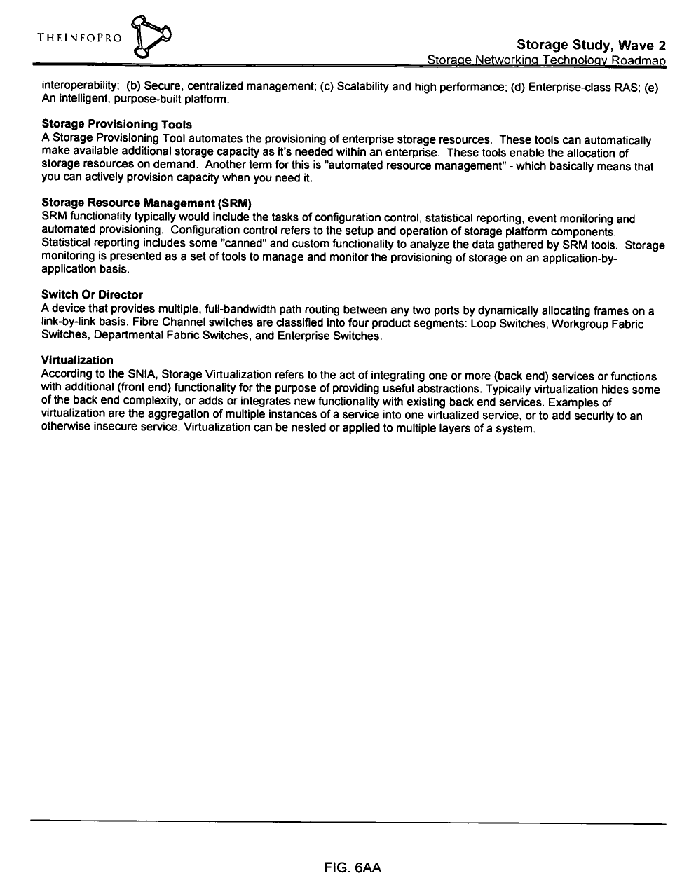

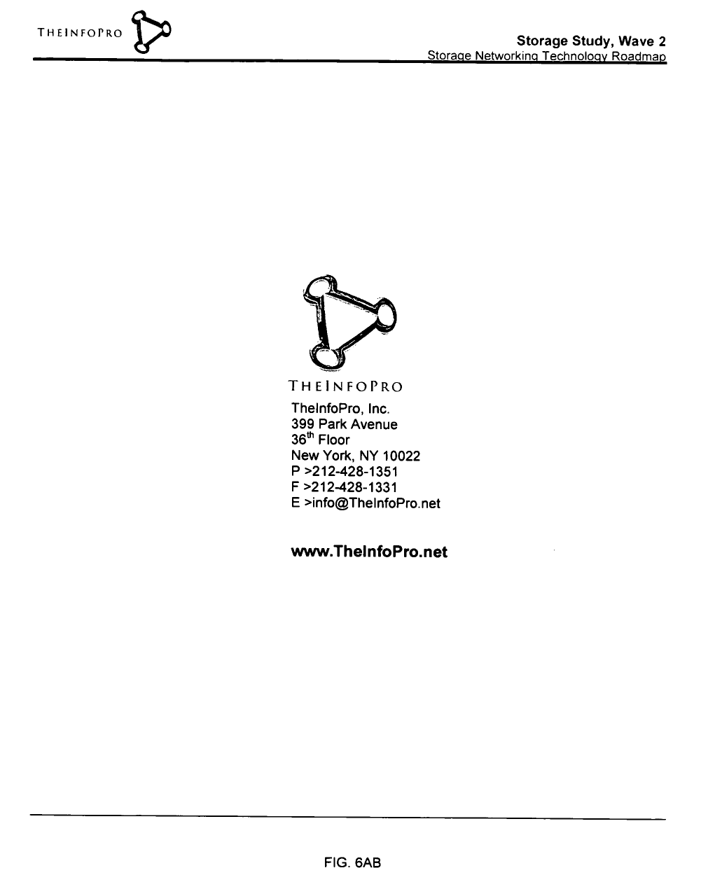

In general, the data is analyzed to generate reports, step 260, such as the reports depicted in FIGS. 5A-5I and FIGS. 6A-6AB, which are further described herein. For qualitative reports, in general, the response data is obtained in an Excel spreadsheet where the first column is the interviewee's industry, the second column is the interviewee's revenue, and the third column includes responses. Additional columns can be added to correlate reference codes to text values. A query framework is used to extract data to create the reports. For example, equations are entered into the new columns (B:B and D:D) in order to translate the codes to text. Below is an example:

=IF(C2=1,“Less than $500 Million”, (IF(C2=2,“$500 Million to less
than $1 Billion”, (IF(C2=3,“$1 Billion to less than $10 Billion”,
(IF(C2=4,“$10 Billion to less than $20 Billion”, (IF(C2=5,“$20 Billion to
less than $30 Billion”, (IF(C2=6,“$30 Billion or more”,
“Unavailable”)))))))))))

These new equation columns are then copied. The paste special/values function is then used to replace the previous equations with their text values, and the original codes are then deleted.

A query is designed that mimics the output that will be required in a report. All of the data is copied out of Access and pasted manually into Excel where it can be formatted. In order to circumvent the Excel text constraint of 255 characters the text is pasted in using the paste special function.

Generating quantitative reports in PowerPoint, such as the reports depicted in FIGS. 5E-5H can be set up using the following template. The one half of the page is made up of a graphic, a chart, a table or other graphic form. The other half of the chart is made up of three boxes, each color-coded. The top box is the question answered on the slide. The middle box contains the analysis of the data shown on the slide. The bottom box includes either relevant narratives or other forms of analysis. Charts are built using the native chart engine in PowerPoint and can be resized to meet the space requirements of the slide.

Referring to FIG. 3, event immediacy is quantified, step 300. In preferred embodiments of the invention, parameters are established to apply to questionnaire responses relating to existing technology use, or technology implementation plans, such as the status answer 1-6 described above. For example, Time Frame (or period) (i) is obtained according to the following scale:
for technologies implemented, weight=1 (because some additional spending is likely, for example, for maintenance or upgrades);
for projects planned for implementation in the near term, weight=1, (because these purchases have likely been made);
for technologies and projects planned for near future, such as next half year, weight=2 (because these projects are budgeted for the near future, these projects are highly likely to occur, and vendors are unlikely to have been selected; thus, these projects represent new spending growth);
for technologies and projects that have been budgeted, but are not in plan, weight=1.5 (because these projects have been budgeted, and tend to be major projects. Generally, these projects are difficult to schedule, and vendors may not have been selected, which represents potential spending growth);
for technologies in a long term plan, such as more than one year away, weight=1 (because these projects are more likely to be cut or rescheduled and vendor selection is uncertain);
for technologies not in plan, weight=0; and
for technologies that were implemented, but are long longer used: Weight=−1 (because these projects are viewed as failures by users, and are likely to be viewed accordingly by others.)

The relevant weight is multiplied against a user response, such as response to a questionnaire or information or data obtained in an interview. The resulting value indicates gives the relative likelihood of significant new projects for each technology.

Wave: (w) each technology study is repeated periodically. Each subsequent study is assigned an identifier, such as Waveₙ. In preferred embodiments, an index is generated for each wave of a study.

Purchaser resources are evaluated, step 320. In preferred embodiments, users, purchasers or other individuals charged with purchasing technology are asked to estimate their budget, or supply information relating to their assets. The Time Frame values are weighted by the user's or entity's resources, such as budget. The weighting scheme is on a quartile scale, which avoids diminishing the value of data obtained from small to medium sized enterprises. The purchaser resource response is Spending: (s). Each spending response is categorized and assigned a Spending Weight (SW), such as:

1=Lowest Spending Quartile

2=Second Lowest Spending Quartile

3=Second Highest Spending Quartile

4=Highest Spending Quartile

The spending quartiles relate to project or event immediacy and expense. For example, a relatively high spending quartile is used for purchases of a relatively great expense and which will occur relatively soon. Spending Weight will also indicate a percent of total market spending accounted for by study participants.

A time frame score is obtained by summing the responses:

Time Frame Score: FSi=Σ(TFi*TWi))*SWs

Where:FSi=Time Frame Score for Period i

TFi=Percent User Responses for Period i

TWi=Time Frame Weight for Period i

SWs=Spending Weight for Spending Group s

An index is generated, step 340 by summing the Time Frame Score:

$$RHIt = {\sum }_{i = 1}^{n} FSi$$

Where: RHIt=Raw Heat Index for technology t
FSi=Time Frame Score
n=Number of Time Frames

The index is converted into a percentage according to:
HIt=((RHIt/RHImn)/(RHlmx/RHImn))* 100
Where: HIt=Standardized Heat Index for technology t
RHIt=Raw Heat Index for technology t
RHImn=Minimum Heat Index Score in Wave w
RHImx=Maximum Heat Index Score in Wave w

The index is on a relative normalized scale of 0-100%. 0 indicates a relatively “cold” technology and 100% indicates a relatively “hot” technology. For example, 100% indicates a technology that will likely be acquired or implemented in the near future, 0% indicates that technology is not likely to be acquired or implemented in the near future.

Assumptions that underlie the analysis and index include, for example the following:

The likelihood that a stated intention, such as an intention to acquire, adopt, implement or other act, will become a reality is related to the elapsed time from the statement of the intention and the execution of that intention.

The level of available resources, such as budget or spending, required to execute the intention is related to execution of the intention.

High levels of spending on technologies has a relatively greater effect on the near term success of a technology than the number of users or entities that implement the technology.

Spending on a particular technology or product will be diminished by a user or entity once the technology is implemented.

Users continue to spend money on a technology after it is implemented, for example, on maintenance and upgrades.

If a user has abandoned a technology or project, it will not be restarted. Abandoning of a project reflects something innately wrong with the project or technology.

The index is compiled to supply the indices depicted in the reports shown in FIGS. 5A-5I. Exemplary reports include for example, End user reports which provide interview data, including detailed narratives of user responses, Investor reports which provide results of interviews of technology analysts and investors, Fusion reports which include the results of the End user and Investor reports, Time Series reports which provided comparative results of analysis over time, for example, for more than one wave.

Referring to FIGS. 5A-5D, which depict reports indicating the relative indices for a particular technology. For example, in FIG. 5A, the highest index score is 56 for Remote Data Mirroring, which indicates that Remote Data Mirroring has a relatively higher likelihood of being purchased and implemented. By comparison, Infiniband, which has the lowest score of 15 is relatively less likely to be purchased or implemented, which indicates that it is either well established or widely implemented, or not appealing to technology purchasers. The reports of FIGS. 5B-5D provide the indices for particular categories of users, such as high capacity users shown in FIG. 5B, company size as shown in FIG. 5C, or spending profile as shown in FIG. 5D.

Other exemplary reports include the reports depicted in FIGS. 5E and 5F. FIGS. 5E and 5F depict reports indicating the relative indices for storage networking technology as the indices change over time. For example, according to FIG. 5E, technologies are listed according to near term user spending and anticipated future spending. FIG. 5F includes indices obtained in two time periods, wave 2 and wave 3. FIG. 5F indicates that technology information or data changes over time. For example, Rapid Restore capabilities has an index score of 94 in wave 2, however, its score decreases to 69 in wave 3, which indicates that the technology may have been widely implemented in the time period between waves 2 and 3 or that it is otherwise less likely to be purchased or implemented.

Another example of reports include the reports depicted in FIGS. 5G-5H, which are reports which indicate the relative indices for technologies and corresponding vendors. For example, FIG. 5G depicts technology indices and the corresponding leading and other vendors that supplied the technology, which has already been installed or implemented. FIG. 5H depict technology indices and the corresponding leading and other vendors that are planned or expected to supply the technology. A further example of a report includes all Time Frame responses in a bar graph, such as the report depicted in FIG. 5I.

Another example of a report is the report depicted in FIGS. 6A-6AB, which shows the qualitative and quantitative results of a study of a particular technology field, namely Storage Networking Technology.

While the invention has been described and illustrated in connection with preferred embodiments, many variations and modifications as will be evident to those skilled in the art may be made without departing from the spirit and scope of the invention, and the invention is thus not limited to the precise details of methodology or construction set forth above as such variations and modifications are intended to be included within the scope of the invention.

What is claimed is:

1. A method of quantifying the respective likelihood of a plurality of events occurring within a specified time frame, said method comprising:
a) receiving a plurality of qualitative data respectively corresponding to each one of said plurality of events;
b) quantifying each one of the qualitative data respectively corresponding to each one of said plurality of events to obtain a plurality of quantitative data respectively corresponding to each one of said plurality of events;
c) processing said plurality of quantitative data to determine the respective likelihood of said plurality of events occurring within said specified time frame; and
d) generating a report that standardizes the respective likelihood of said plurality of events occurring within said specified time frame.

2. A method according to claim 1, wherein each one of said plurality of events comprises the adoption of a particular technology.

3. The method of claim 1, wherein said step of receiving a plurality of qualitative data comprises querying a plurality of users for their need for the technologies.

4. The method of claim 3, wherein said step of receiving a plurality of qualitative data comprises querying users on their intentions to acquire the technologies.

5. The method of claim 3, wherein said step of receiving a plurality of qualitative data comprises querying users on the probability of their acquiring the technologies.

6. The method of claim 3, wherein said step of receiving a plurality of qualitative data comprises querying users on the immediacy of their need for the technology.

7. The method of claim 3, wherein said step of receiving a plurality of qualitative data comprises determining, for each one of said plurality of users, whether a user has the funding to acquire the technology.

8. The method of claim 3, wherein said step of receiving a plurality of qualitative data comprises querying users on their spending on products related to the technology.

9. The method of claim 8, wherein said step of receiving a plurality of qualitative data comprises prompting querying users to select one of a plurality of different time periods for their spending on products related to the technology and said step of quantifying each one of said qualitative data comprises assigning a numeric value to each one of said plurality of different time periods.

10. The method of claim 8, wherein said step of processing said plurality of quantitative data comprises determining spending weights according to spending quartile.

11. The method of claim 8, wherein said step of processing said plurality of quantitative data comprises assigning a time frame weight to each one of the plurality of different time periods and calculating a time frame score for each one of the plurality of different time periods based on the percentage of usage responses, the time frame weight and the spending weights for said respective time period.

12. The method of claim 8, wherein said step of processing said plurality of quantitative data comprises summing the time frame scores to obtain a raw heat index for each technology and scaling the scores to lie between a range of numeric values.

13. A computer readable medium storing program code which, when executed, causes a computer to perform a method of quantifying the respective likelihood of a plurality of events occurring within a specified time frame, the method comprising:
a) receiving a plurality of qualitative data respectively corresponding to each one of said plurality of events;
b) quantifying each one of the qualitative data respectively corresponding to each one of said plurality of events to obtain a plurality of quantitative data respectively corresponding to each one of said plurality of events;
c) processing said plurality of quantitative data to determine the respective likelihood of said plurality of events occurring within said specified time frame; and
d) generating a report that standardizes the respective likelihood of said plurality of events occurring within said specified time frame.

14. The computer readable medium storing program code according to claim 13, wherein each one of said plurality of events comprises the adoption of a particular technology.

15. The computer readable medium storing program code according to claim 13, wherein said step of receiving a plurality of qualitative data comprises querying a plurality of users for their need for the technologies.

16. The computer readable medium storing program code according to claim 15, wherein said step of receiving a plurality of qualitative data comprises querying users on their intentions to acquire the technologies.

17. The computer readable medium storing program code according to claim 15, wherein said step of receiving a plurality of qualitative data comprises querying users on the probability of their acquiring the technologies.

18. The computer readable medium storing program code according to claim 15, wherein said step of receiving a plurality of qualitative data comprises querying users on the immediacy of their need for the technology.

19. The computer readable medium storing program code according to claim 15, wherein said step of receiving a plurality of qualitative data comprises determining, for each one of said plurality of users, whether the user has the funding to acquire the technology.

20. The computer readable medium storing program code according to claim 15., wherein said step of receiving a plurality of qualitative data comprises querying users on their spending on products related to the technology.

21. The computer readable medium storing program code according to claim 20, wherein said step of receiving a plurality of qualitative data comprises prompting querying users to select one of a plurality of different time periods for their spending on products related to the technology and said step of quantifying each one of said qualitative data comprises assigning a numeric value to each one of said plurality of different time periods.

22. The computer readable medium storing program code according to claim 20, wherein said step of processing said plurality of quantitative data comprises determining spending weights according to spending quartile.

23. The computer readable medium storing program code according to claim 20, wherein said step of processing said plurality of quantitative data comprises assigning a time frame weight to each one of the plurality of different time periods and calculating a time frame score for each one of the plurality of different time periods based on the percentage of usage responses, the time frame weight and the spending weights for said respective time period.

24. The computer readable medium storing program code according to claim 20, wherein said step of processing said plurality of quantitative data comprises summing the time frame scores to obtain a raw heat index for each technology and scaling the scores to lie between a range of numeric values.
